(19) United States
(12) Patent Application Publication
(10) Pub. No.: US 2025/0209398 A1
(43) Pub. Date: Jun. 26, 2025

(54) LOCATION AND MARKING SYSTEM AND SERVER

(71) Applicant: PACIFIC GAS AND ELECTRIC COMPANY, Oakland, CA (US)

(72) Inventors: Shelbey Warner, Oakland, CA (US); Michael Robert Wolf, Oakland, CA (US); Billy Dean Glenn, Martinez, CA (US); Michael Hansen, Paso Robles, CA (US); Morgan Sharif, Oakland, CA (US); Jason Klemm, Concord, CA (US); Zachary Scofield, San Jose, CA (US); Edward Dotson, San Jose, CA (US); Travis Huston, San Jose, CA (US); Steven Walker, Grass Valley, CA (US); Michael S. Glass, Oakland, CA (US); Patrick Buckles, San Ramon, CA (US); Tony Chen, Oakland, CA (US); Sivakrishna Jasti, Newark, CA (US); Nikita Anokhin, Oakland, CA (US); Elyse Cheung-Sutton, Oakland, CA (US); Charlene Chi-Johnston, Oakland, CA (US); Jonathan Vega, Oakland, CA (US); Pavani Mantravadi, Oakland, CA (US); Scott Metcalf, Oakland, CA (US); Ashok Pithadiya, Oakland, CA (US); Theron Roby, Oakland, CA (US); Anna Usach, Oakland, CA (US); Robert Mulder, Oakland, CA (US); Genaro Marmolejo Servin, Oakland, CA (US)

(21) Appl. No.: 19/007,298

(22) Filed: Dec. 31, 2024

Related U.S. Application Data
(63) Continuation-in-part of application No. 18/419,524, filed on Jan. 22, 2024, now abandoned.
Application No. 18/419,524 is a continuation of application No. 17/688,595, filed on Mar. 7, 2022, now abandoned.
Application No. 17/688,595 is a continuation of application No. 16/932,044, filed on Jul. 17, 2020, now abandoned.
(60) Provisional application No. 62/875,435, filed on Jul. 17, 2019.

(51) Int. Cl. G06Q 10/0631; G06Q 10/0637; G06Q 50/06

(52) U.S. Cl. CPC G06Q 10/06315; G06Q 10/06314; G06Q 10/0637; G06Q 50/06

(57) ABSTRACT

A novel location and marking system is configured to provide a seamless in-the-field access to resource and asset information databases with automated functionality that effectively and more efficiently manages, controls, and distributes data according to some embodiments. These assets include sites of residential and business gas, electrical, and/or water and sewer conduits and metering systems, as well as related underground infrastructure that can be susceptible to earthquakes, ground disturbances, and other emergency situations. In some embodiments, the systems enables utilities to manage assets in real-time, provide map asset status, and provide automatic ticket routing, dispatching and management. In some embodiments, the system is configured to ingest 811 tickets and output the 811 ticket information on a dashboard. In some embodiments, the system includes an AI model configured to predict a ticket completion duration.

### CROSS-REFERENCE RELATED APPLICATIONS

This application is a continuation-in-part of U.S. patent application Ser. No. 18/419,524, filed Jan. 22, 2024, entitled “Location and Marking System and Server”, which is a continuation of U.S. patent application Ser. No. 17/688,595, filed Mar. 7, 2022, entitled “Location and Marking System and Server”, which is a continuation of U.S. patent application Ser. No. 16/932,044, filed Jul. 17, 2020, entitled “Location and Marking System and Server”, which claims the benefit of and priority to U.S. Provisional Application No. 62/875,435, filed Jul. 17, 2019, entitled “Location and Marking System and Server”, the entire contents of which are incorporated herein by reference.

### BACKGROUND

Utility workers and supervisors strive to maintain efficient and safe working practices in spite of the volume of information sources, the way in which this information is reviewed and exchanged, and the use of processes that are encumbered by manual procedures. These issues can become especially acute when attempting to address emergency or evacuation situations.

Accordingly, there is a need to provide seamless in-the-field access to resource and asset information databases with automated functionality that effectively and more efficiently manages, controls, and distributes data. Such systems could enable utilities to manage assets in real-time, provide map asset status, and provide automatic ticket routing, dispatching and management. For example, the system could generate maps with identifiers or components of an active division including tickets of one or more assets of an active division. These assets could include sites of residential and business gas, electrical, and/or water and sewer conduits and metering systems, as well as related underground infrastructure that can be susceptible to earthquakes, ground disturbances, and other emergency situations.

### SUMMARY

Some embodiments of present disclosure provide various exemplary technically improved computer-implemented platforms, systems and methods, including methods for providing a seamless in-the-field access to resource and asset information databases with automated functionality that effectively and more efficiently manages, controls, and distributes data such as: receiving location information data associated with one or more assets; generating one or more maps based on the location information data; displaying the one or more maps through a graphical user interface provided by the computing device, where each map covers at least a portion of the one or more assets; receiving an input from the user to select one or more map types based on the one or more assets; and displaying the one or more selected map types to the user.

In some embodiments, the system includes a location and marking system configured to be in electronic communication with a plurality of users, the location and marking system comprising a non-transitory computer-readable program memory storing instructions, a non-transitory computer-readable data memory, and a processor configured to execute the instructions. The processor is configured to execute the instructions to receive location information data associated with one or more assets; generate one or more maps based on the location information data; display the one or more maps through a graphical user interface, where each map covers at least a portion of the one or more assets; receive an input to select one or more map types based on the one or more assets; and display the one or more selected map types.

In some embodiments, the system comprises a non-transitory computer-readable medium including one or more sequences of instructions that, when executed by one or more processors, cause the performance of the following operations: receiving location information data associated with one or more assets; generating one or more maps based on the location information data; displaying the one or more maps through a graphical user interface provided by the computing device, each map covering at least a portion of the one or more assets; receiving an input from the user to select one or more map types based on the one or more assets; and displaying the one or more selected map types to the user.

In some embodiments, the disclosure is directed to a system for 811 ticket ingestion and assignment comprising one or more computers comprising one or more processors and one or more non-transitory computer readable media, the one or more non-transitory computer readable media including instructions stored thereon that when executed by the one or more processors cause the one or more computers to receive, by the one or more processors, an 811 ticket from an 811 ticket provider. Some embodiments include a computer implemented step to analyze, by the one or more processors, an 811 ticket content. Some embodiments include a step to generate, by the one or more processors, a ticket dashboard comprising the 811 ticket content in a different format than which the 811 ticket was received.

In some embodiments, the 811 ticket is received as an email. In some embodiments, analyzing the 811 ticket includes determining an email type. In some embodiments, analyzing the 811 ticket includes determining if the 811 ticket needs to be processed. In some embodiments, the one or more non-transitory computer readable media further include instructions stored thereon that when executed by the one or more processors cause the one or more computers to create, by the one or more processors, a technician ticket by extracting information from the 811 ticket and formatting the information for display on the ticket dashboard.

In some embodiments, the one or more non-transitory computer readable media further include instructions stored thereon that when executed by the one or more processors cause the one or more computers to assign, by the one or more processors, a unique folder ID to the technician ticket. In some embodiments, the one or more processors cause the one or more computers to organize, by the one or more processors, a plurality of technician tickets into workflows for individual technicians based on the unique folder ID.

In some embodiments, the system is configured to generate assignments for a plurality of technician tickets based on key words in the 811 ticket and/or defined geographical boundaries associated with the 811 ticket. In some embodiments, the system is configured to automatically generate an encompassing shape around a work area on a map based on an analysis of the email.

In some embodiments, the system further comprises a duration model configured to generate a prediction including an amount of time needed for a technician to complete a ticket. In some embodiments, completing the ticket includes the technician determining a type of utilities, their location, and/or any specific requirements or precautions within geographical boundaries from the 811 ticket. In some embodiments, the duration model includes an AI model configured to analyze information from the 811 ticket. In some embodiments, the AI model is configured to include ticket size, ticket description, and/or Geographical Information System (GIS) asset counts in for the prediction. In some embodiments, the AI model is configured to output a quantile regression including a prediction interval for ticket duration. In some embodiments, the AI model is configured to output a mean regression for ticket duration.

### DESCRIPTION OF THE DRAWINGS

FIG. 1 illustrates a location application display page generated by the location and marking system according to some embodiments.

FIG. 2 illustrates a supervisor user interface generated by the location and marking system according to some embodiments.

FIG. 3 illustrates a map with ticket marker display page generated by the location and marking system according to some embodiments.

FIG. 4 illustrates a map with gas distribution display page generated by the location and marking system according to some embodiments.

FIG. 5 illustrates mobile information display page generated by the location and marking system according to some embodiments.

FIG. 6 illustrates service location and location GSR data displays generated by the location and marking system according to some embodiments.

FIG. 7 illustrates a ticket information display generated by the location and marking system according to some embodiments.

FIG. 8 illustrates a map information display generated by the location and marking system according to some embodiments.

FIG. 9 illustrates user mobile display pages generated by the location and marking system according to some embodiments.

FIG. 10 illustrates a dashboard folder view generated by the location and marking system according to some embodiments.

FIG. 11 illustrates a ticket list with map search display generated by the location and marking system according to some embodiments.

FIG. 12 illustrates example locate forms generated by the location and marking system according to some embodiments.

FIG. 13 illustrates supervisor user interface functions generated by the location and marking system according to some embodiments.

FIG. 14 illustrates a ticket-list split screen generated by the location and marking system according to some embodiments.

FIGS. 15-17 illustrate real-time dashboard displays generated by the location and marking system according to some embodiments.

FIG. 18 illustrates a ticket list display generated by the location and marking system according to some embodiments.

FIGS. 19-24 illustrate ticket selected displays generated by the location and marking system according to some embodiments.

FIGS. 25-26 illustrate reassign ticket displays generated by the location and marking system according to some embodiments.

FIGS. 27-28 illustrate performance display pages generated by the location and marking system according to some embodiments.

FIG. 29 illustrates a real-time dashboard display page generated by the location and marking system according to some embodiments.

FIG. 30 illustrates reassign ticket display generated by the location and marking system according to some embodiments.

FIGS. 31-34 illustrate active real-time dashboard displays generated by the location and marking system according to some embodiments.

FIGS. 35-36 illustrate real-time dashboard displays generated by the location and marking system according to some embodiments.

FIG. 37 illustrates a map view display generated by the location and marking system according to some embodiments.

FIG. 38 illustrates a ticket view display generated by the location and marking system according to some embodiments.

FIGS. 39-40 illustrate ticket and map displays generated by the location and marking system according to some embodiments.

FIG. 41 illustrates reassign ticket displays generated by the location and marking system according to some embodiments.

FIG. 42 illustrates an order summary display generated by the location and marking system according to some embodiments.

FIG. 43 illustrates a ticket and order detail display generated by the location and marking system according to some embodiments.

FIGS. 44-45 illustrate closing soon displays generated by the location and marking system according to some embodiments.

FIG. 46 illustrates a “tickets closing soon” list display generated by the location and marking system according to some embodiments.

FIG. 47 show a chart of the results for this non-limiting example according to some embodiments.

FIG. 48 depicts key performance metrics for the system's AI model(s) in identifying risky 811 tickets in accordance with some embodiments.

FIG. 49 shows steps implemented by a ticket management platform portion of the system according to some embodiments.

FIG. 50 illustrates a supervisor dashboard graphical user interface according to some embodiments.

FIG. 51 shows a ticket detail GUI according to some embodiments.

FIG. 52 shows user movement tracking overlaid on a map for a given work order according to some embodiments.

FIG. 53 shows an output on the location and marking GUI identifying a high-risk dig-indig in location and area boundary according to some embodiments.

FIG. 54 shows a non-limiting system architecture for the ticket management platform according to some embodiments.

FIG. 55 shows the ticket ingestion portion of the system architecture of FIG. 54 according to some embodiments.

FIG. 56 shows the poller and document update handler process portion of the system architecture of FIG. 54 according to some embodiments.

FIG. 57 shows the positive response step function process portion of the system architecture of FIG. 54 according to some embodiments.

FIG. 58 shows the prediction model portion of the system architecture of FIG. 54 according to some embodiments.

FIG. 59 shows a process flow for a duration predictions artificial intelligence (AI) model according to some embodiments.

FIG. 60 shows a ticket header in the L&M supervisor dashboard showing mean and upper interval prediction according to some embodiments.

FIG. 61 shows a portion of the unitization dashboard according to some embodiments.

FIG. 62 illustrates a non-limiting system architecture integrating the duration model according to some embodiments.

FIG. 63 illustrates a computer system enabling systems and methods in accordance with some embodiments.

### DETAILED DESCRIPTION

Before any embodiments of the invention are explained in detail, it is to be understood that the invention is not limited in its application to the details of construction and the arrangement of components set forth in the following description or illustrated in the following drawings. Some embodiments of the system are configured to be combined with some other embodiments and all embodiments are capable of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use the system. Various modifications to the illustrated embodiments will be readily apparent to those skilled in the art, and the generic principles recited according to some illustrated embodiments are configured to be applied to and/or combined with some other illustrated embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some embodiments of the invention include various methods, apparatuses (including computer systems) that perform such methods, and computer readable media containing instructions that, when executed by computing systems, cause the computing systems to perform such methods. For example, some non-limiting embodiments comprise certain software instructions or program logic stored on one or more non-transitory computer-readable storage devices that tangibly store program logic for execution by one or more processors of the system and/or one or more processors coupled to the system.

Some embodiments relate to improved data processing in electronic devices including, for example, an entity or machine such as a location and marking execution system that provides a technological solution where users can more efficiently process and view and/or retrieve useful data based on improvements in capturing and manipulating utilization, job history, and job hour history data. For example, some embodiments generally describe non-conventional approaches for systems and methods that capture, manipulate utilization, job history, and job hour history data that are not well-known, and further, are not taught or suggested by any known conventional methods or systems. Moreover, in some embodiments, the specific functional features are a significant technological improvement over conventional methods and systems, including at least the operation and functioning of a computing system that are technological improvements. In some embodiments, these technological improvements include one or more aspects of the systems and method described herein that describe the specifics of how a machine operates, which the Federal Circuit makes clear is the essence of statutory subject matter.

Some embodiments described herein include functional limitations that cooperate in an ordered combination to transform the operation of a data repository in a way that improves the problem of data storage and updating of databases that previously existed. In particular, some embodiments described herein include system and methods for managing single or multiple content data items across disparate sources or applications that create a problem for users of such systems and services, and where maintaining reliable control over distributed information is difficult or impossible.

The description herein further describes some embodiments that provide novel features that improve the performance of communication and software, systems, and servers by providing automated functionality that effectively and more efficiently manages resources and asset data for a user in a way that cannot effectively be done manually. Therefore, the person of ordinary skill can easily recognize that these functions provide the automated functionality, as described herein according to some embodiments, in a manner that is not well-known, and certainly not conventional. As such, some embodiments of the invention described herein are not directed to an abstract idea and further provide significantly more tangible innovation. Moreover, the functionalities described herein according to some embodiments were not imaginable in previously-existing computing systems, and did not exist until some embodiments of the invention solved the technical problem described earlier.

Some embodiments include a location and marking system with improved usability, safety, quality, and performance for technicians over conventional methods. In some embodiments, some quality related metrics of the system include, but are not limited to, at least one or more of the following: global reset signal (“GSR”) capability, as-builts available in the system application, standard work processes reinforced and improved through a user-interface, image and/or video upload capability, priority ticket visibility (e.g. overdue, due soon tickets), historical ticket information and field intelligence, instrument calibration verification, operator qualification verification, a safety related metrics, emergency ticket visibility, field intelligence, training access, ticket enrichment including risk score, and unitization.

Some embodiments include a system comprising operations for retrieving location or Global Positioning System (GPS) position data from at least one coupled or integrated asset, and retrieving at least one map and/or image from a mapping component of the system representing at least one asset location. Further, based at least in part on the location or GPS position data, the system is configured to display at least one map or map image including a representation of the asset in a position on the map image based at least in part on the actual physical location of the asset according to some embodiments. In some embodiments, the system is configured to generate and display the map (e.g., covering at least a portion of one or more asset or infrastructure service areas) on a display, such as a graphical user interface (GUI) provided by one or more user devices. In some embodiments, the map can include one or more identifiers or components of an active division. In some embodiments, the map is configured to include one or more tickets pending or issued to one or more assets of an active division. In some embodiments, the system is configured to allow a user to select an active division to enable the system to selectively display one or more assets such as gas distribution assets, gas transmission assets, and/or electrical distribution assets. In some embodiments, assets include sites of residential and business gas conduits and/or metering systems, as well as other underground systems.

Some embodiments include a display of an activity or ticket log. For example, in some embodiments, one or more user displays are configured to display the activity of one or more users. In some embodiments, the log comprises a date and time of one or more activities of one or more users.

In some embodiments, the system comprises program logic enabling a map manager that is configured to select or define a map type based on one or more assets, infrastructure, or a service provided. For example, in some embodiments, an interface of the system is configured to select one or more of a gas distribution map type, a gas transmission map type, an electrical distribution map type, an electrical transmission map type, a hydroelectric map type, and/or a fiber map type. In some embodiments, the system is configured to enable a user to also select a desired division for display as at least a portion of a displayed map upon a user's selection of the gas distribution map type, a gas transmission map type, an electrical distribution map type, an electrical transmission map type, a hydroelectric map type, and/or a fiber map type.

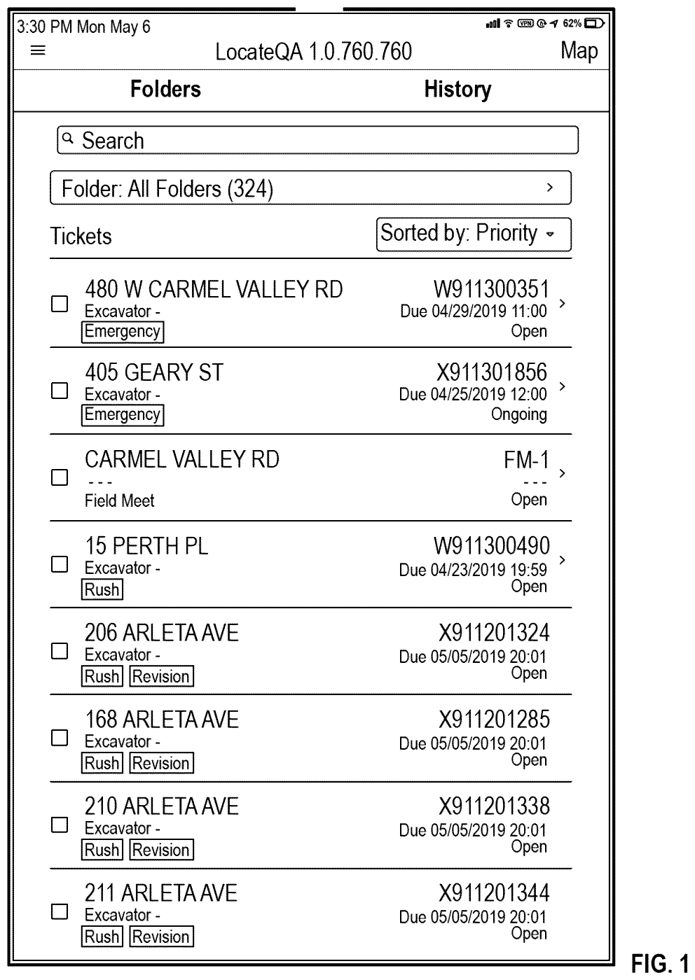

In some embodiments, the system includes a location application with access to location folders and history. For example, FIG. 1 illustrates a location application display page generated by the location and marking system according to some embodiments. In some embodiments, the display can comprise a list of one or more open or active tickets. For example, some embodiments include a location address and/or business name, a description of the tooling and/or asset, a status (such as emergency, rush, etc.), an assigned ID, a due date, and/or an open status. In some embodiments, the display is configured to be sorted or filtered. For example, in some embodiments, the display results or content are configured to be sorted by priority.

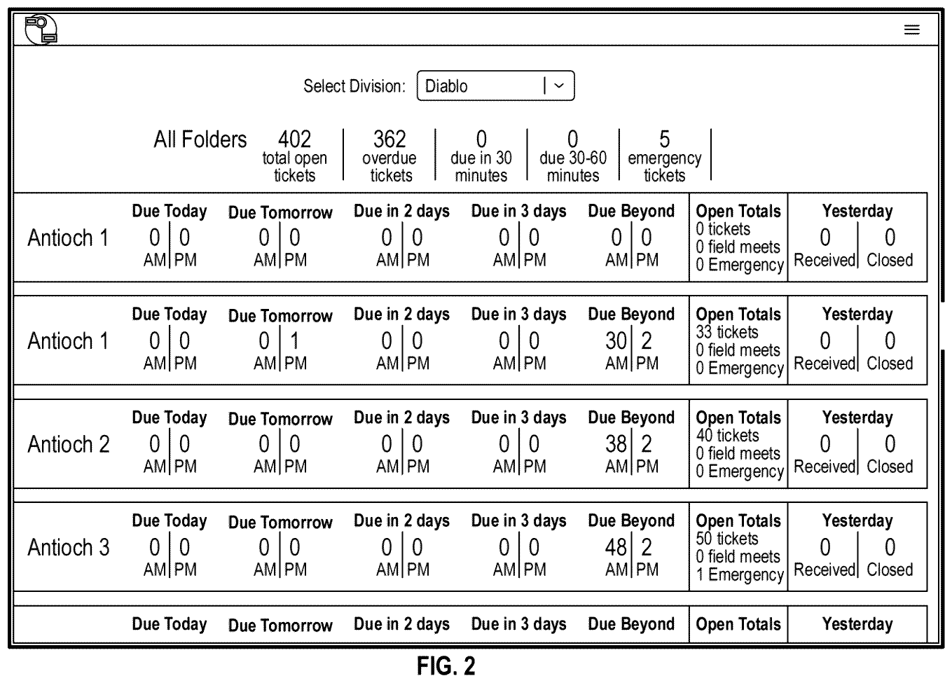

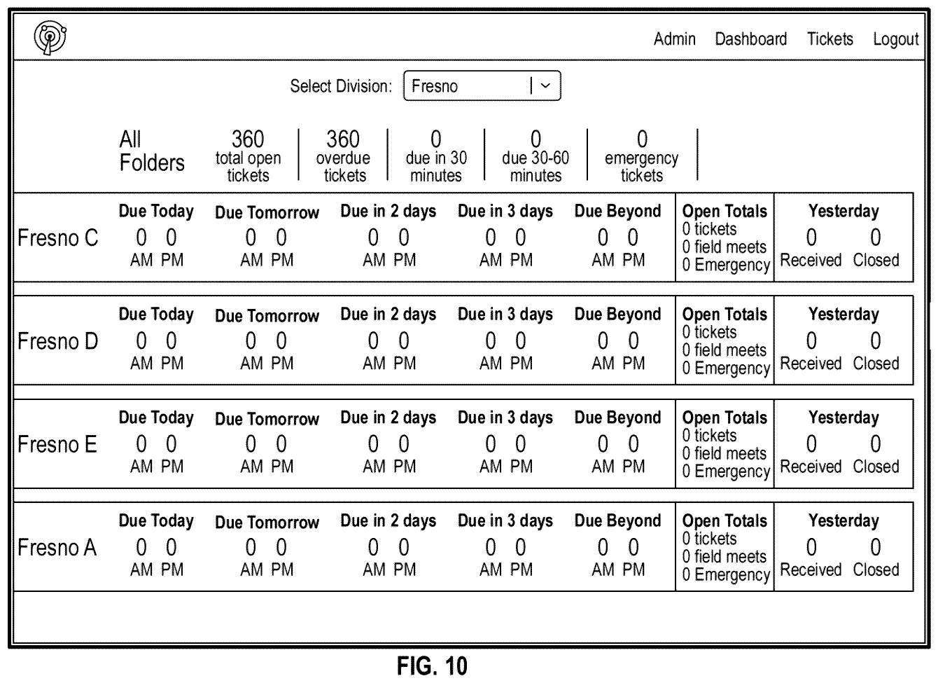

In some embodiments, the system is configured to generate a user interface for use by a manager or supervisor. In some embodiments, the interface is configured to enable seamless management of tickets and/or technician workload. For example, FIGS. 2 and 10 illustrate a supervisor user interface generated by the location and marking system according to some embodiments. In some embodiments, the user interface is configured to include a display of ticket statistics, including, but not limited to, total open tickets, overdue tickets, tickets due in 30 minutes, tickets due in 30 to 60 minutes, and/or the number of emergency tickets. Further, the display is configured to comprise a list of tickets due including, but not limited to one or more of: statistics for due today, due tomorrow, due in two days, due in three days, and/or due beyond; and/or open tickets including one or more of: tickets, field meets, emergency, and tickets received yesterday including those received and/or closed.

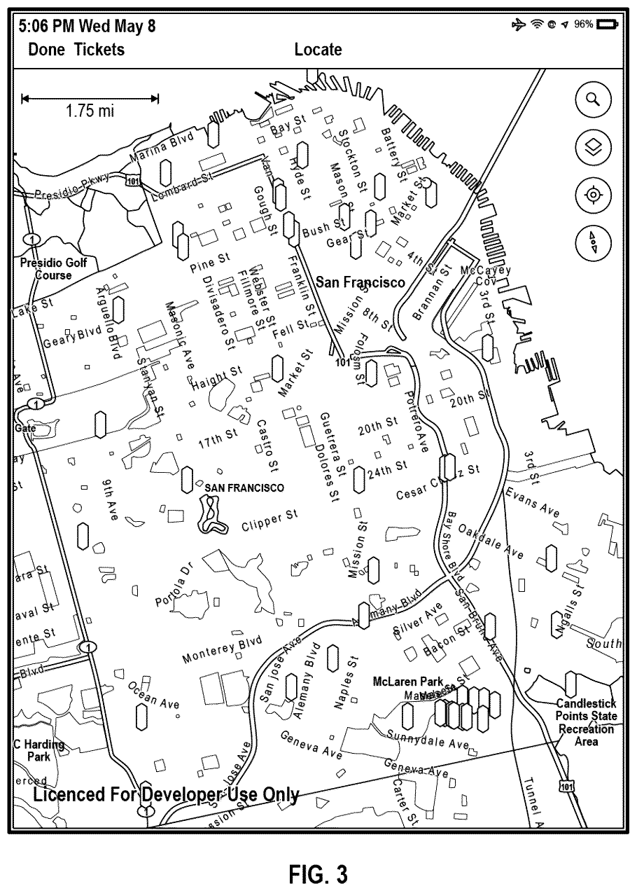

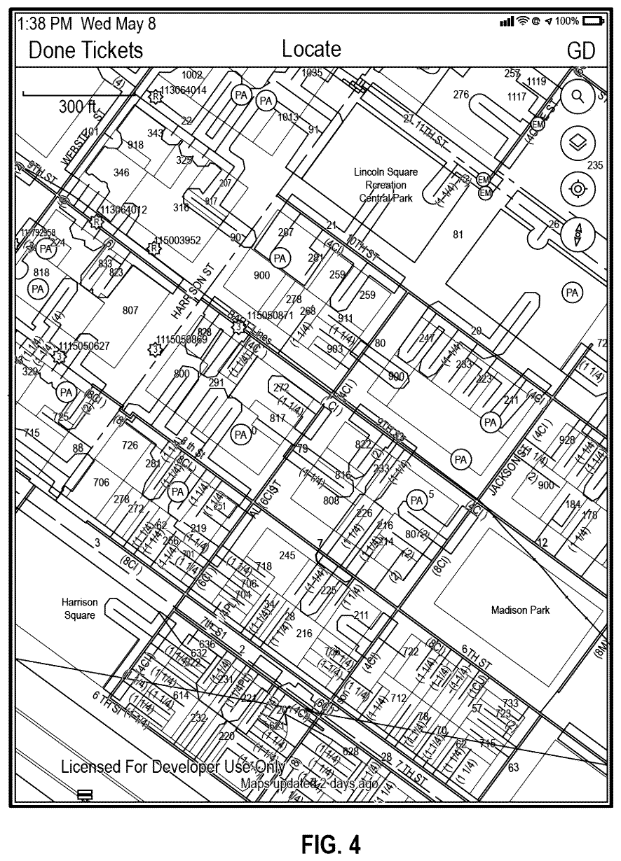

Some embodiments include a locate application that includes visual features to improve the technician experience. For example, FIG. 3 illustrates a map with a ticket marker display page generated by the location and marking system according to some embodiments. FIG. 4 illustrates a map with gas distribution display page generated by the location and marking system according to some embodiments. Some embodiments include a water distribution display, fuel distribution display, and any distributable resource display.

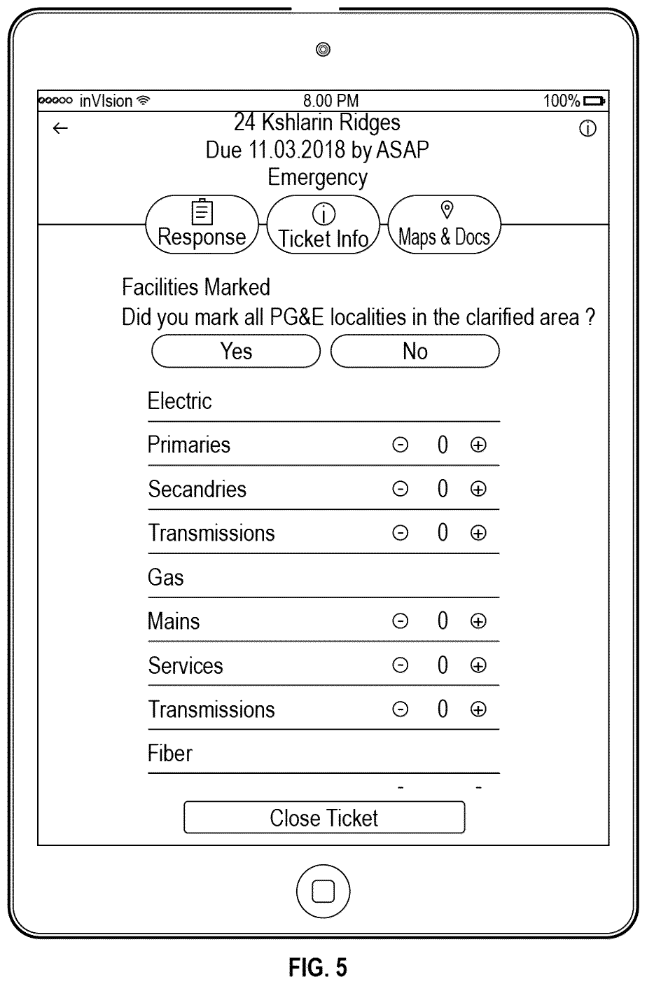

Some embodiments include displays, such as information displays for mobile devices such as tablets and mobile phones. In some embodiments, the displays are configured to enable an operator to enter information regarding a resource location, site, and/or an on-going emergency as the resource location or site. For example, FIG. 5 illustrates mobile information display page generated by the location and marking system according to some embodiments. In some embodiments, the display is configured to enable one or more of an entry of response and ticket information, entry of information related to assets at the location, and/or retrieval or maps and other documents related to the asset.

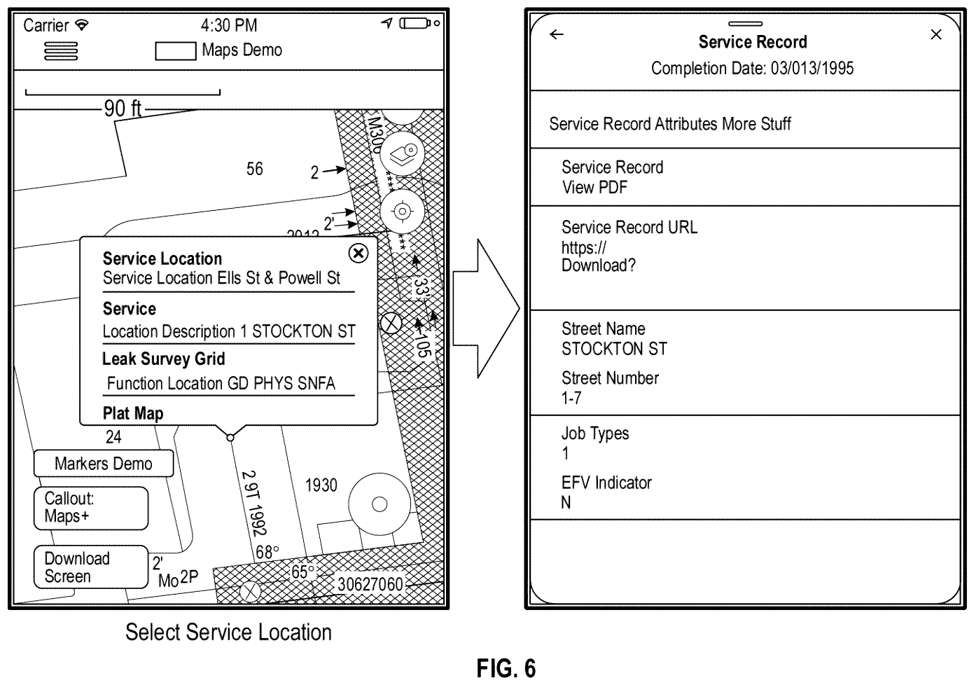

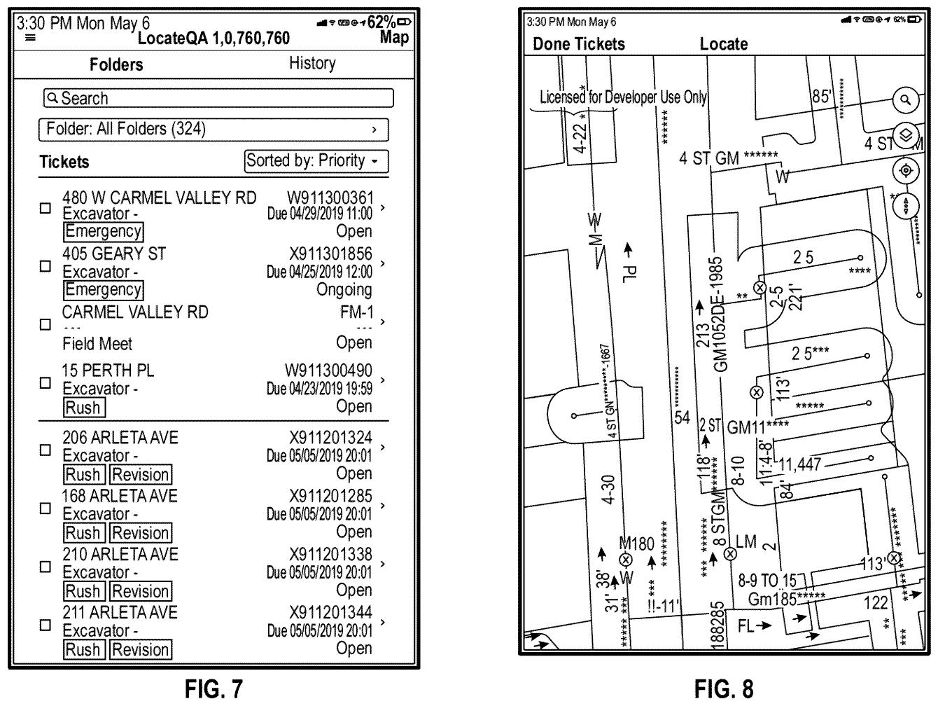

In some embodiments, the system is configured to provide service and asset location and mapping features. In some embodiments, the system is configured to display a map for selection of a service location. In some further embodiments, the system is configured to view location GSR data. For example, FIG. 6 illustrates service location and location GSR data displays generated by the location and marking system according to some embodiments. In some embodiments, the system is configured to automatically map one or more assets, and any associated tickets identifying where and when work is scheduled and/or completed. In some embodiments, the system is configured to display street-level data and/or satellite imagery layers. Further examples are shown in FIG. 7, illustrating a ticket information display generated by the location and marking system according to some embodiments, and FIG. 8 illustrates a map information display generated by the location and marking system according to some embodiments.

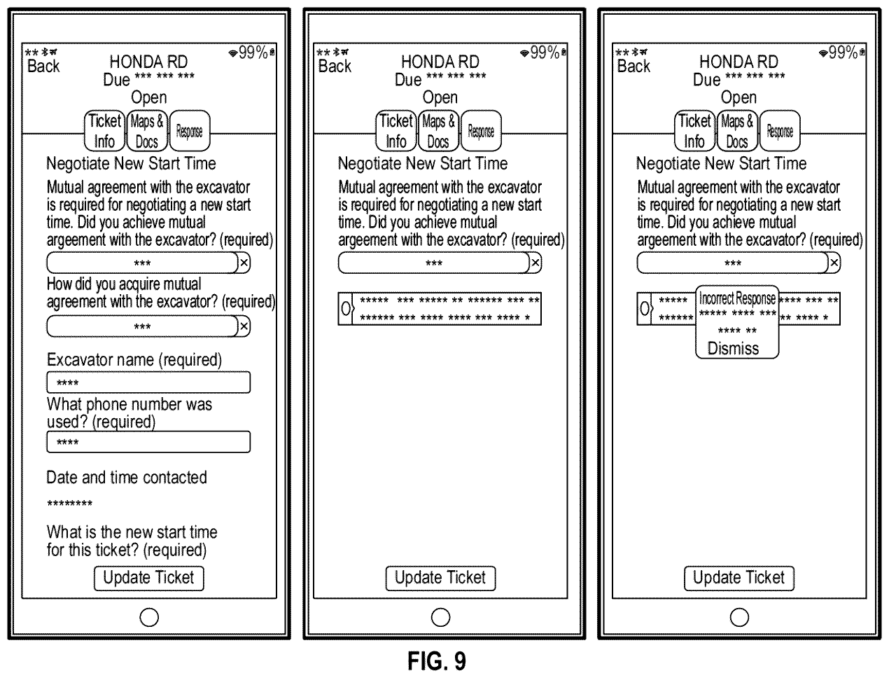

In some embodiments, the system is configured to enable a user-interface providing ticket update features enabling a user to rapidly review and update a ticket. For example, FIG. 9 illustrates user mobile display pages generated by the location and marking system according to some embodiments. In some embodiments, the interface is configured to enable a user to modify a time (e.g., a start time), and/or enable communication with an excavator.

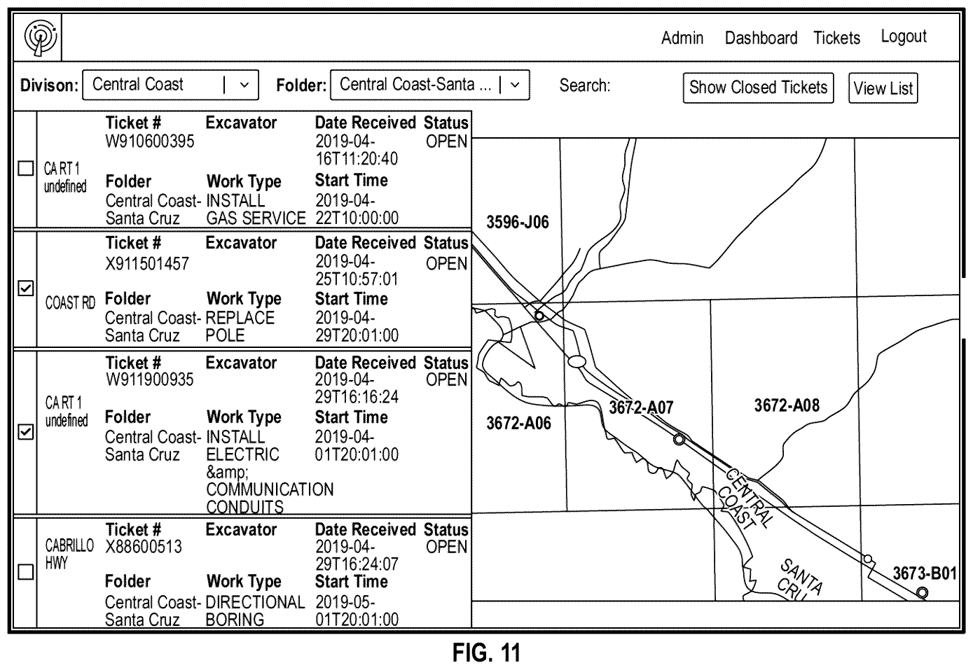

FIG. 11 illustrates a ticket list with map search display generated by the location and marking system according to some embodiments. As shown, in some embodiments, the system is configured to display tickets of a selected division on one side of the display, and/or a map of at least a portion of the division on the opposite side of the display. In some embodiments, at least one parameter of the ticket and/or location of the ticket can be displayed on the map.

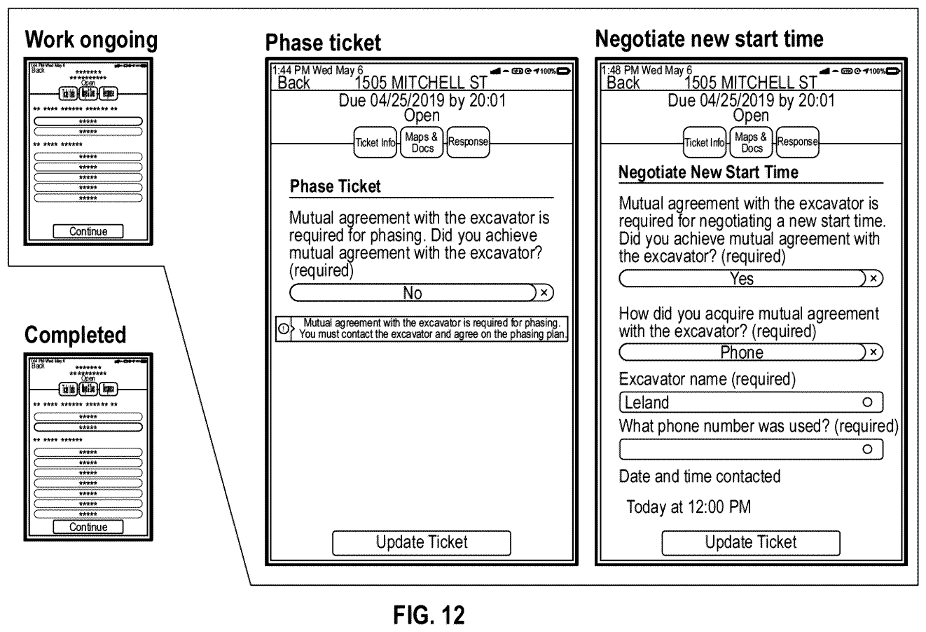

In some embodiments, the system is configured to generate built-in controls and “dynamic required fields” enabling and/or reinforcing standard work. For example, FIG. 12 illustrates example locate forms generated by the location and marking system according to some embodiments. In some embodiments, the forms include, but are not limited to, one or more of: a work on-ongoing form, a completed form or display, a phase ticket, and/or a phase ticket with features enabling a user to negotiate a new start time for the ticket and/or one or more work procedures of the ticket.

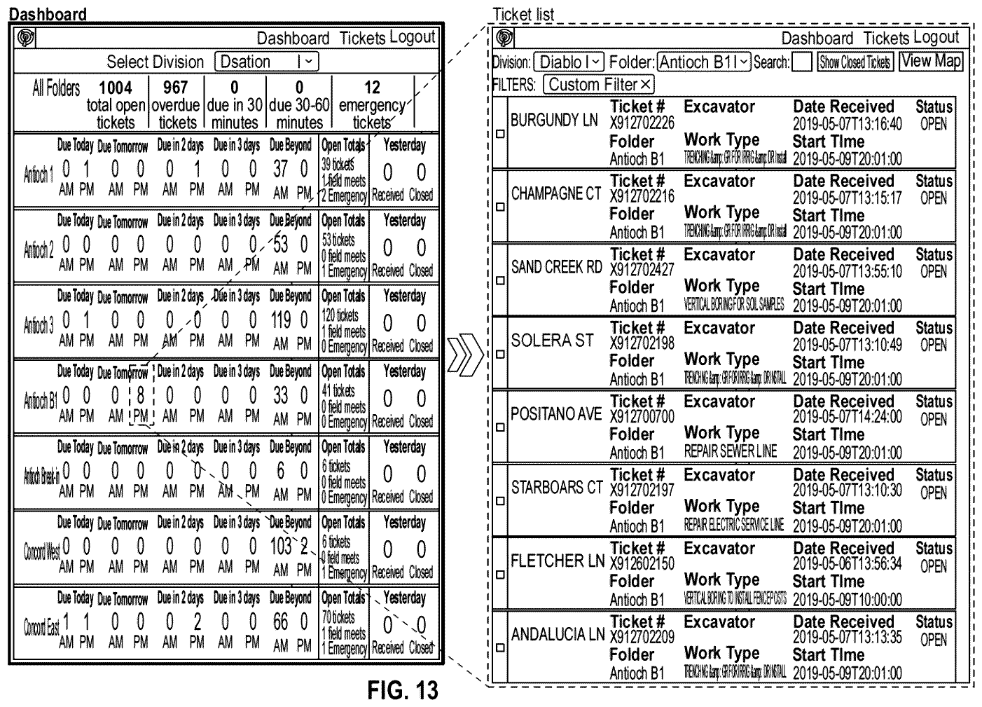

In some embodiments, the system is configured to generate data displays providing certain users (e.g., managers or supervisors) a holistic view of folders, including an ability to rapidly view individual ticket details. For example, FIG. 13 illustrates supervisor user interface functions generated by the location and marking system according to some embodiments. In some embodiments, the user interface can include a display of ticket statistics, including, but not limited to, one or more of: total open tickets, overdue tickets, tickets due today, due tomorrow, due in two days, due in three days, and/or due beyond; and/or open tickets including field meets, emergency, and/or tickets received yesterday including those received and/or closed. In some embodiments, the system is configured to enable the user to click or access any statistic to provide an expanded ticket or ticket list display. Further, in some embodiments, the system is configured to enable the user to click or access any ticket in the ticket list, or any details of the ticket to further display underlying or related information.

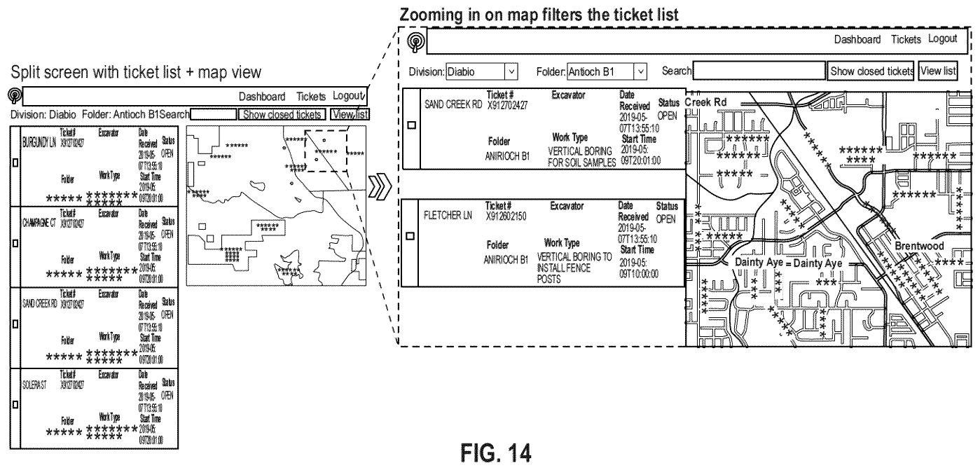

In some embodiments, the system is configured to enable a split screen display view allowing users to review both ticket and map details within a single display or portion of the display. For example, FIG. 14 illustrates a ticket-list split screen generated by the location and marking system according to some embodiments. In some embodiments, the system is configured to enable the user to click or access any statistic of a ticket and/or a portion of a map to provide an expanded ticket or ticket list display. Further, in some embodiments, the system is configured to enable the user to click, access, and/or use a zoom feature for any ticket in the ticket list, details of the ticket, and/or any mapped ticket to further display underlying or related information.

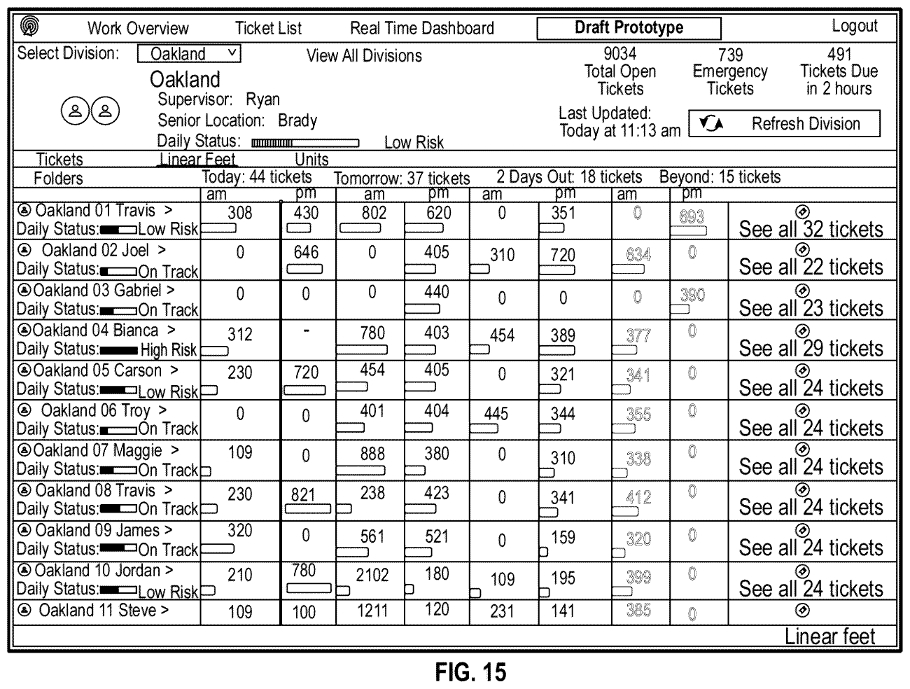

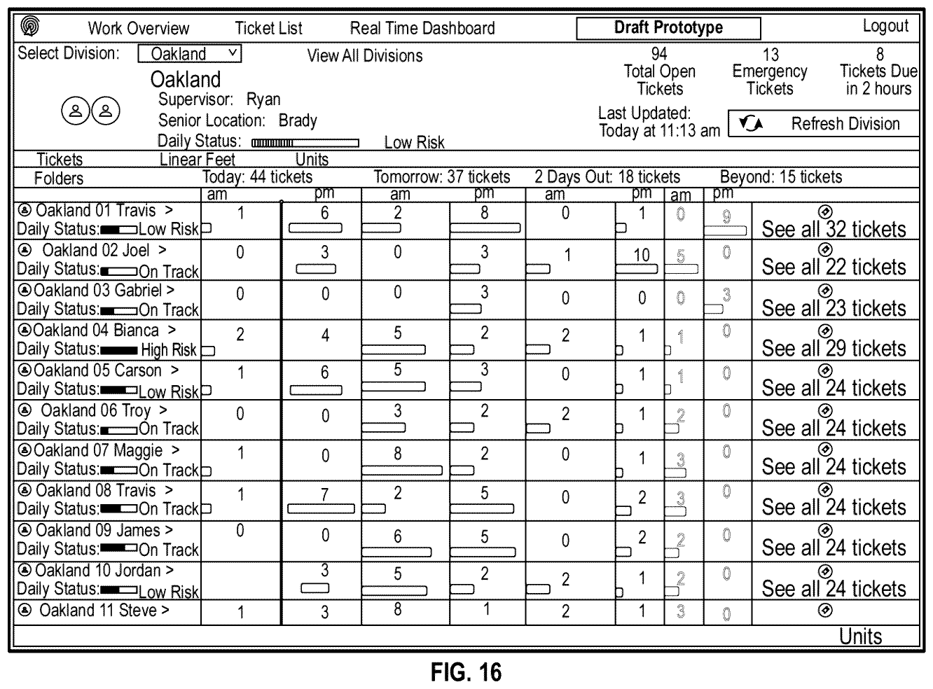

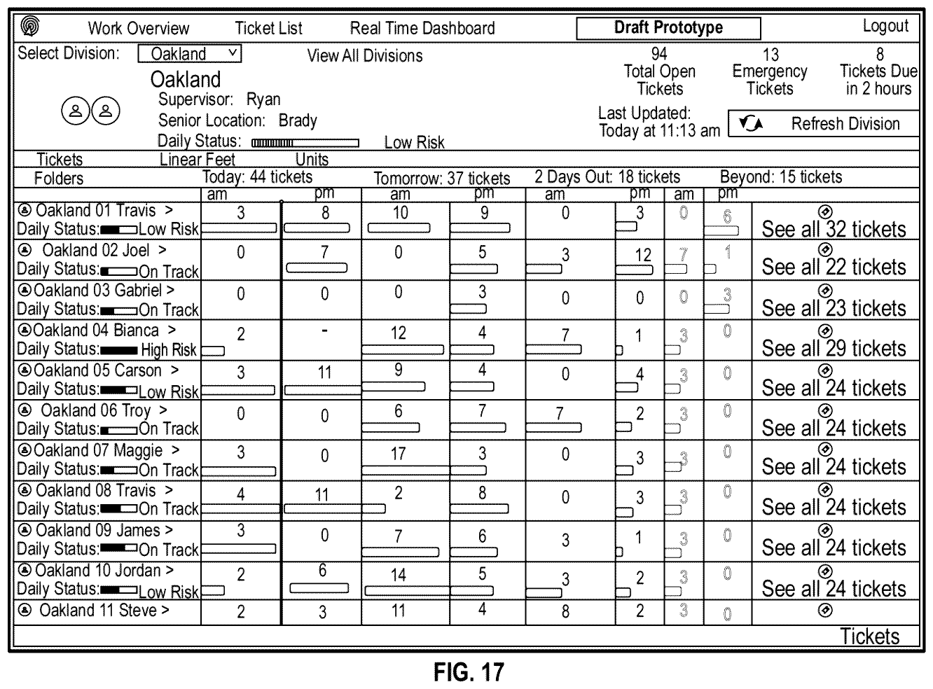

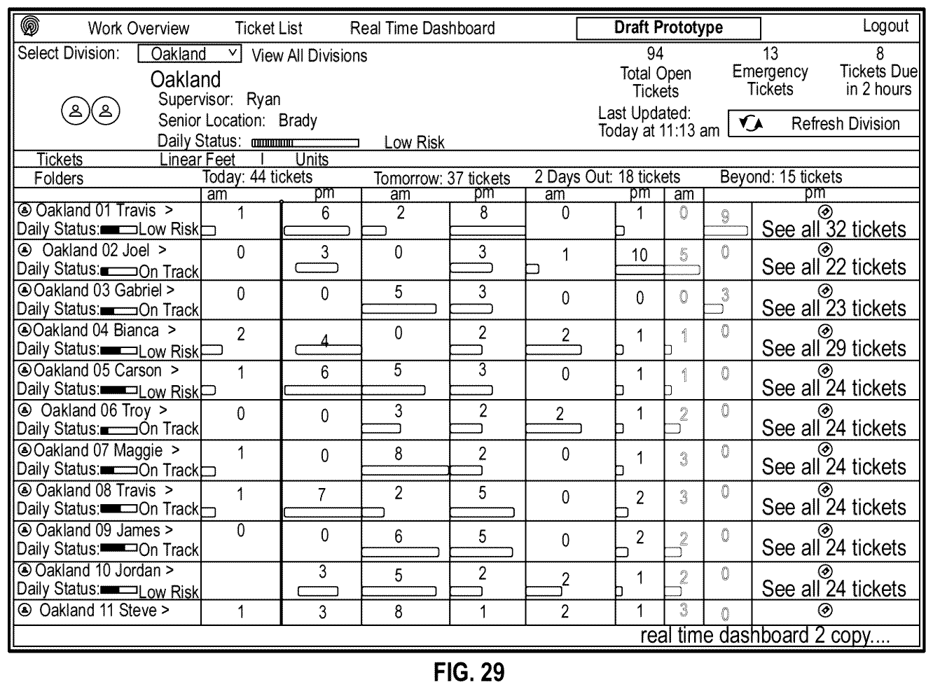

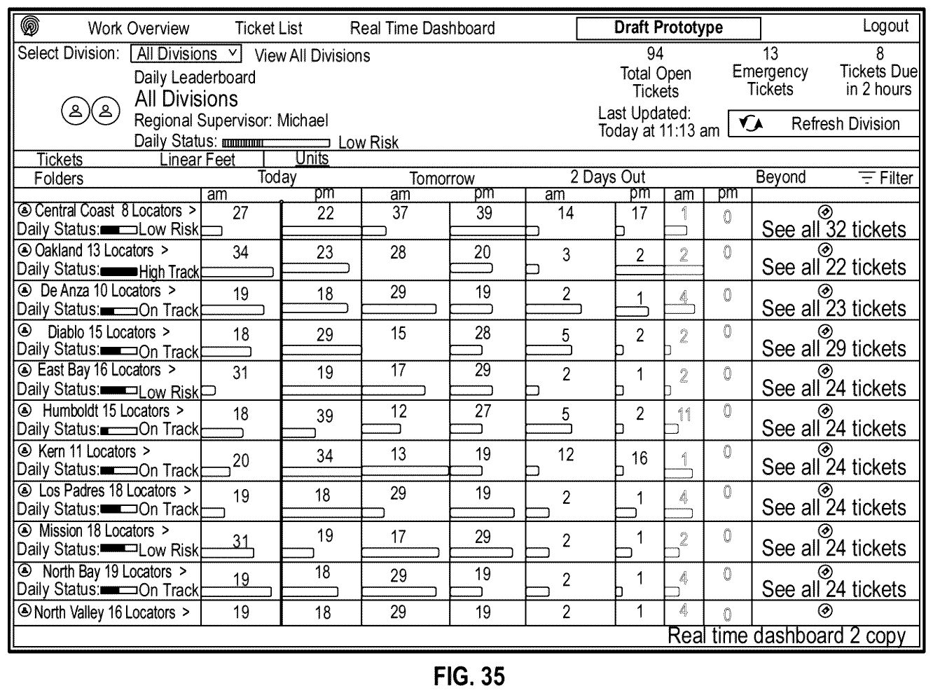

In some embodiments, the system is configured to generate dashboard display of tickets filtered by division, linear feet, and/or units. For example, FIGS. 15-17, 29, and 35 illustrate real-time dashboard displays generated by the location and marking system according to some embodiments. In some embodiments, the display includes a ticket list with ticket statistics for today, tomorrow, two days out, and beyond; and/or the user is able to view all tickets, and/or total open tickets, emergency tickets, and/or tickets due in two hours.

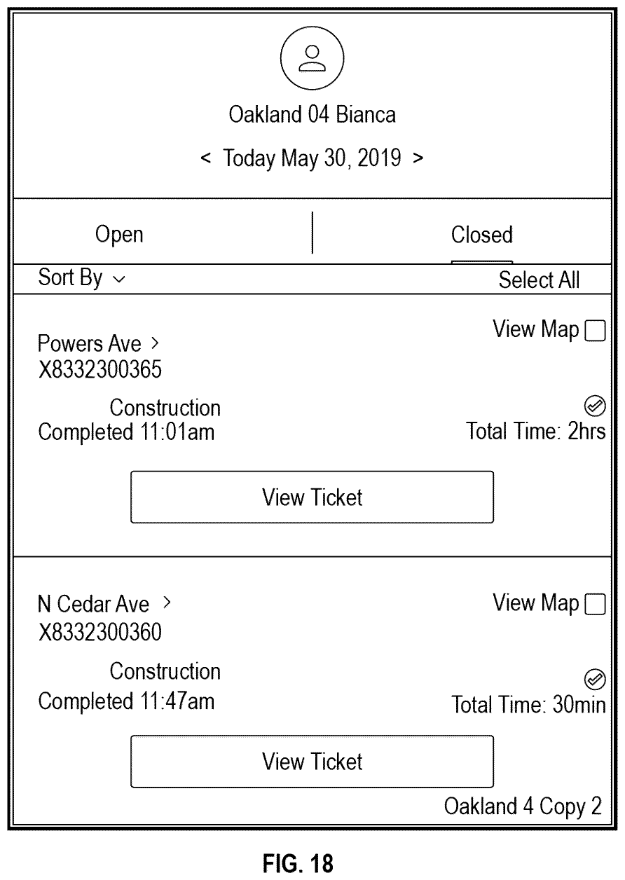

In some embodiments, the system is configured to displayed and/or scroll a ticket or list of tickets. For example, FIG. 18 illustrates a ticket list display generated by the location and marking system according to some embodiments. In some embodiments, the system is configured to enable the user to view the ticket on a map and/or view open or closed ticket details.

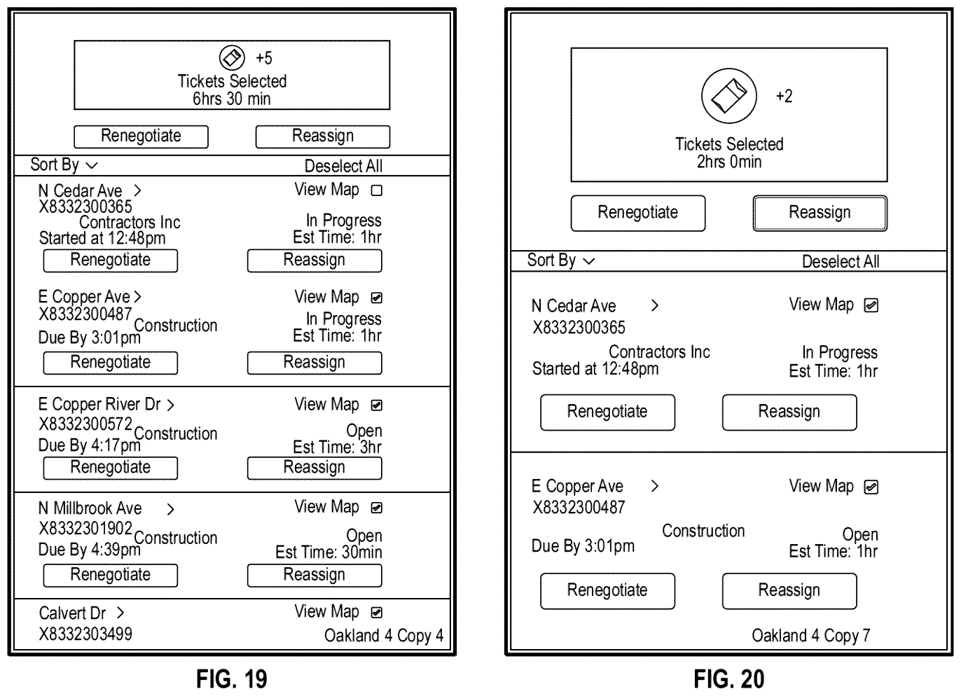

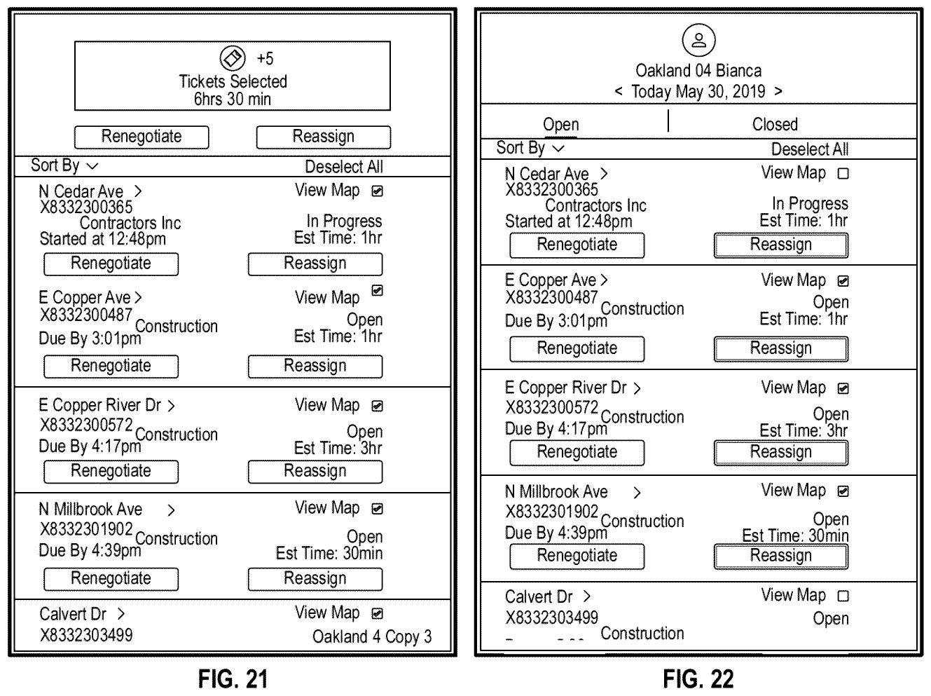

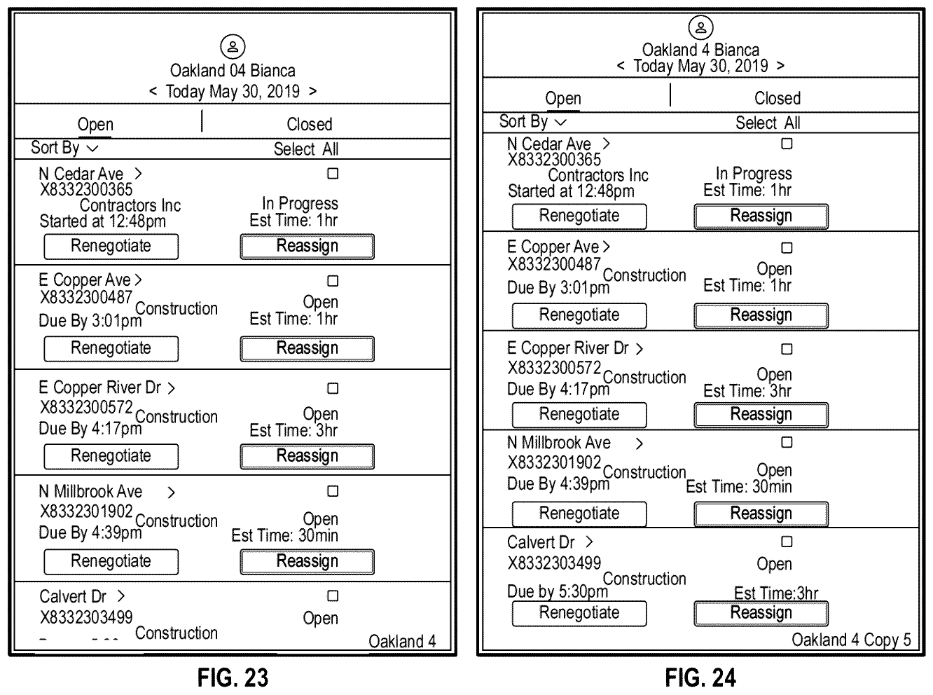

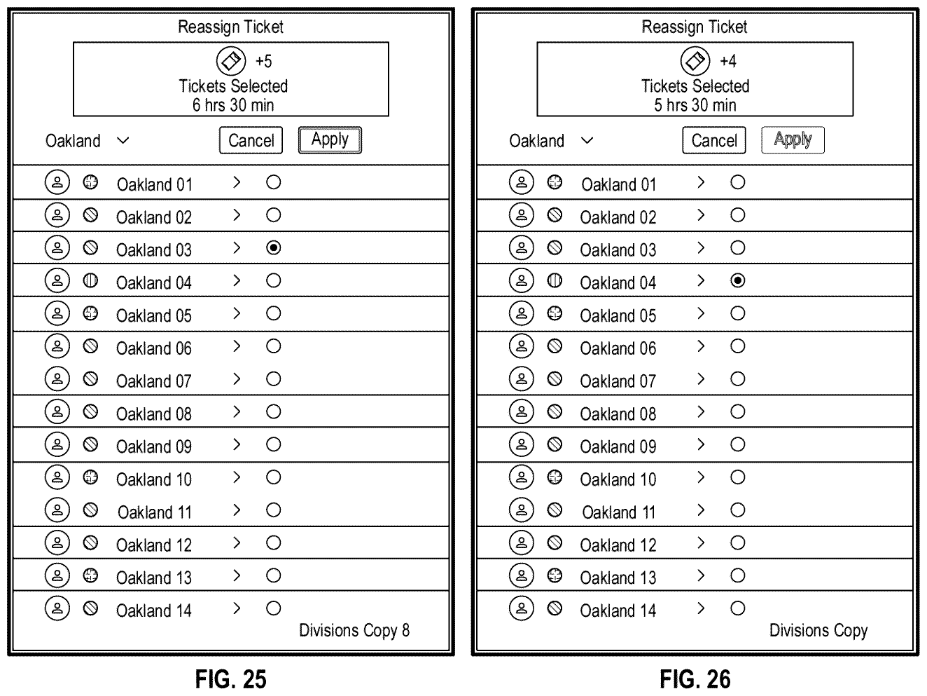

In some embodiments, the display includes lists of selectable tickets including selection options for opening, closing, reassigning, and/or renegotiating. For example, FIGS. 19-24 illustrate ticket selected displays generated by the location and marking system according to some embodiments, and FIGS. 25-26 illustrate reassign ticket displays generated by the location and marking system according to some embodiments.

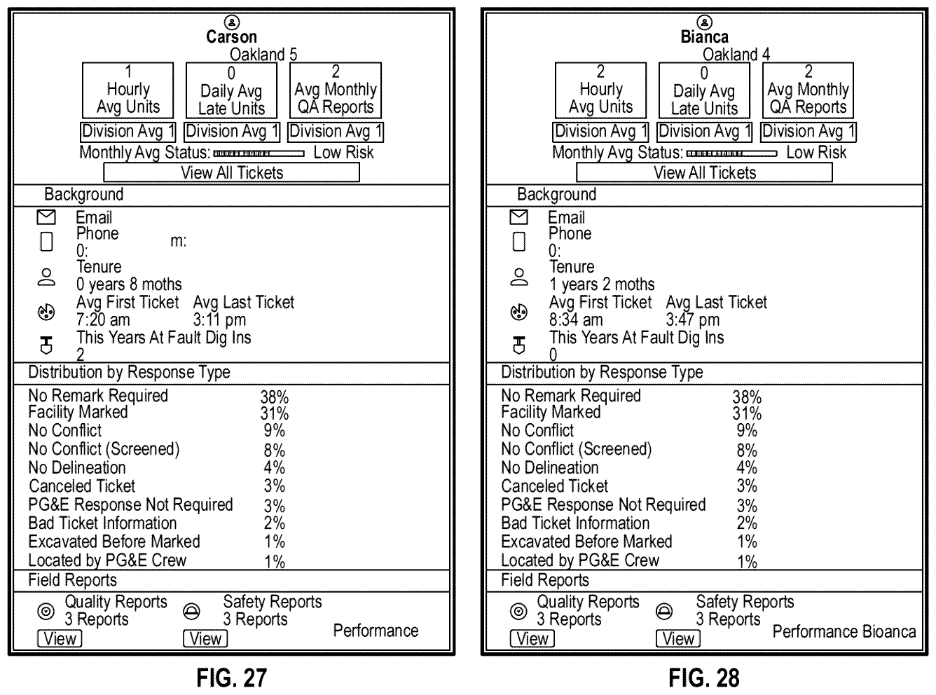

In some embodiments, the system is configured to display ticket statistics for individual users or employees. For example, FIGS. 27-28 illustrate performance display pages generated by the location and marking system according to some embodiments. In some embodiments, the displays include distribution by response type, access to quality or field reports and data, a risk assessment, and unit statistics.

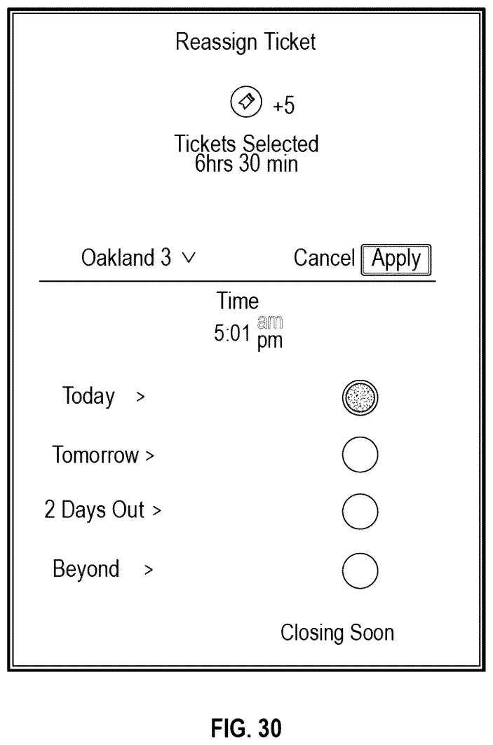

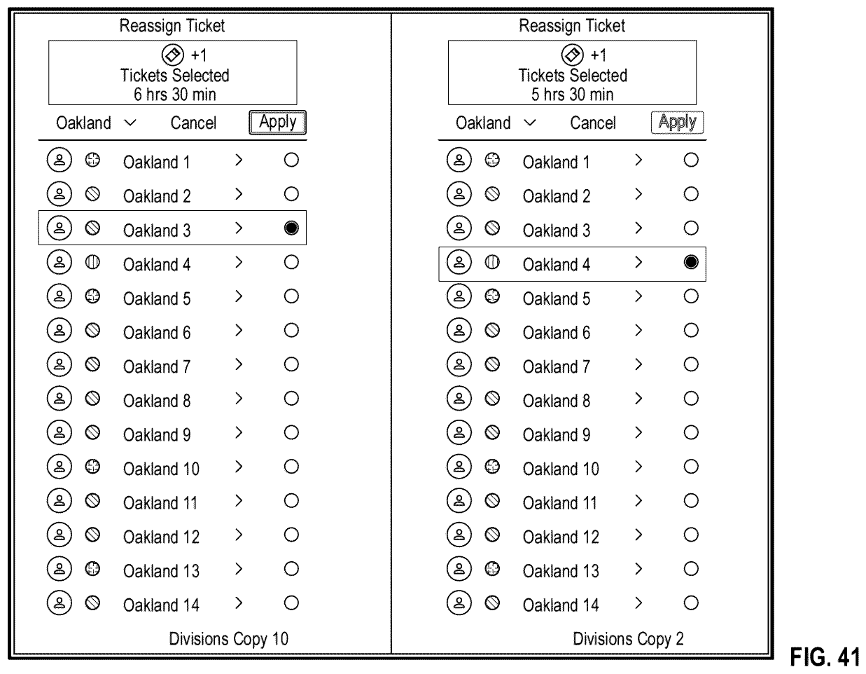

FIGS. 30 and 41 illustrate reassign ticket display generated by the location and marking system according to some embodiments. In some embodiments, the system is configured to enable ticket reassignment for a selected ticket, with reassignment time and/or date options.

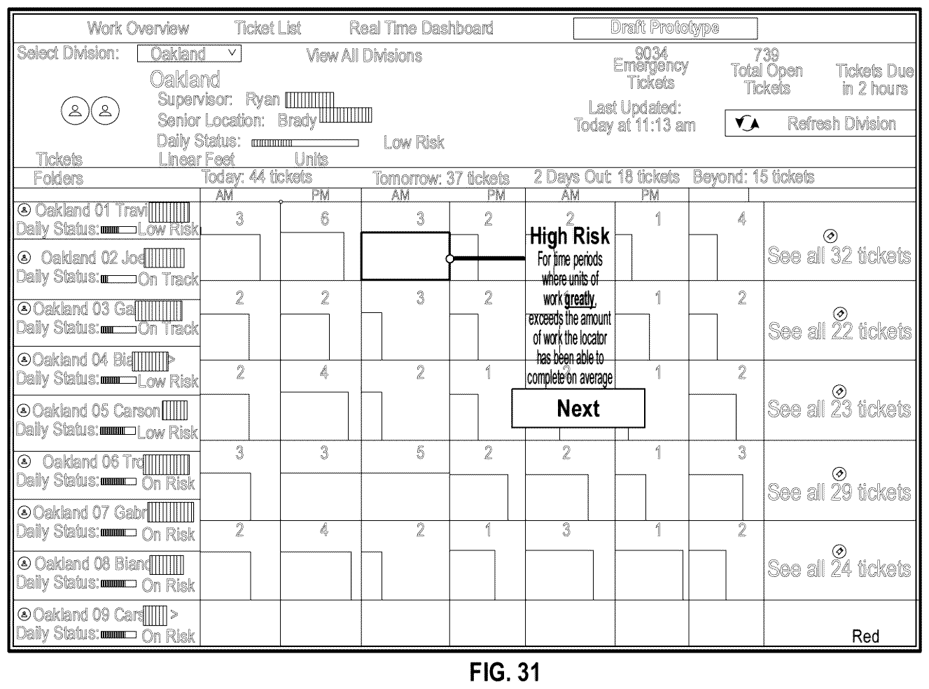

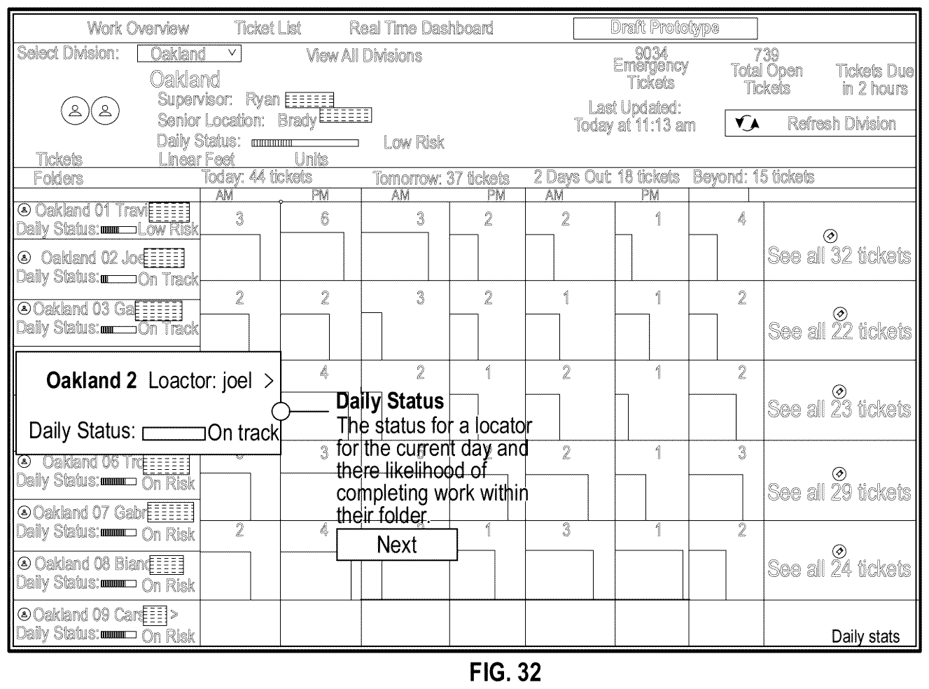

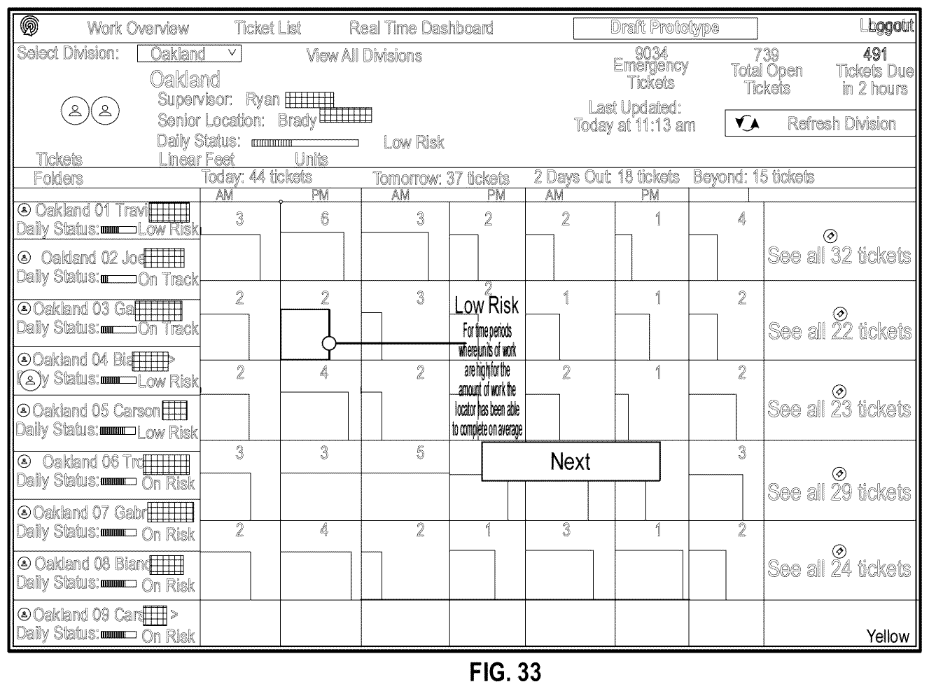

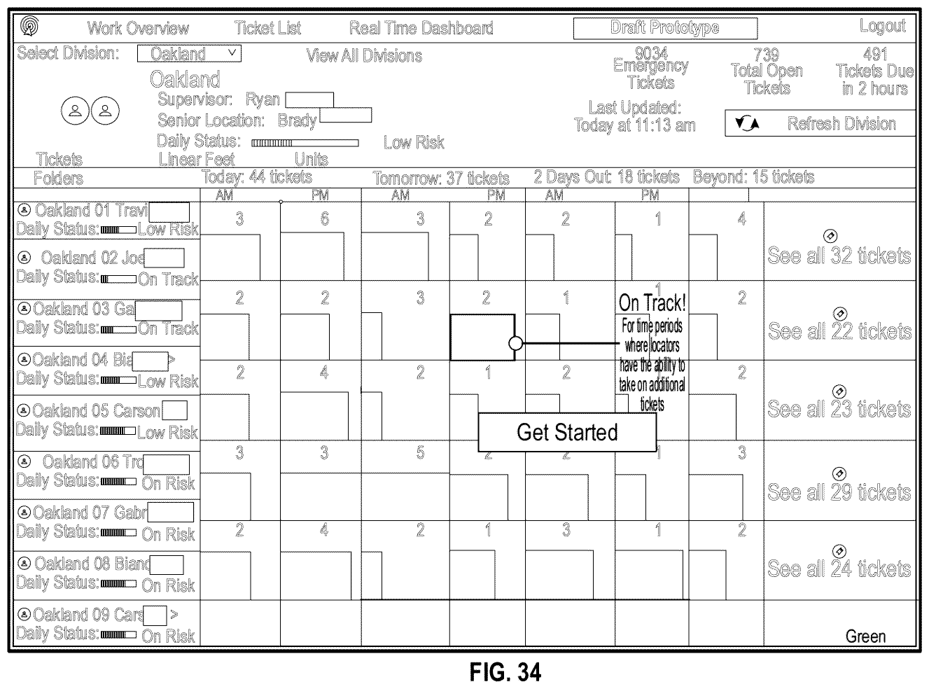

FIGS. 31-34 illustrate active real-time dashboard displays generated by the location and marking system according to some embodiments. In some embodiments, the display is configured to illustrate elevated risk time periods, a daily status indicator including an indication of likelihood of work completion, and/or an indicator of low or high-risk periods when units of work for the amount of work the technician has completed on average, and/or an on-track indicator for time periods where locations have the ability to take on additional work.

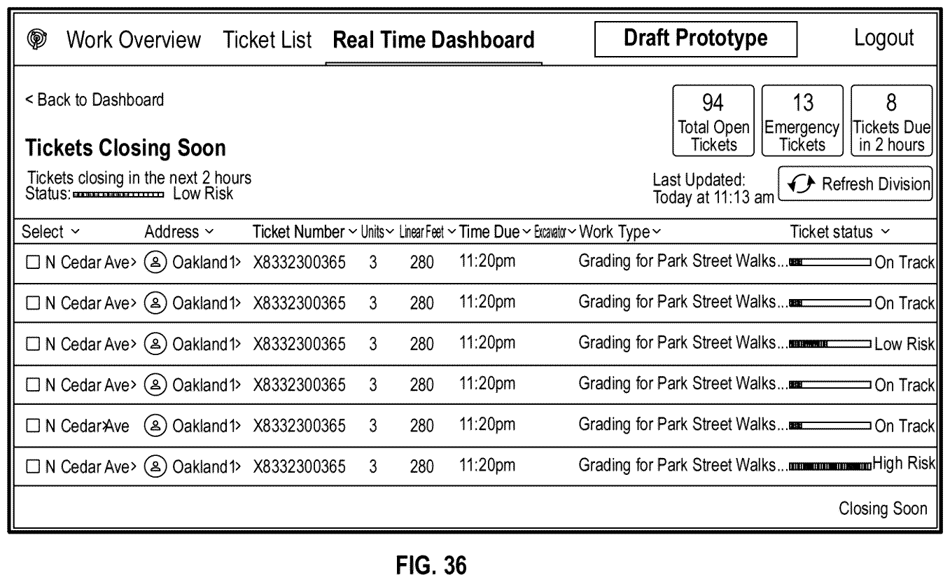

FIG. 36 illustrates a real-time dashboard display showing tickets closing soon, according to some embodiments. In some embodiments, the display is configured to include the address, ticket number, units, linear feet, time due, excavator, work type, and ticket status information.

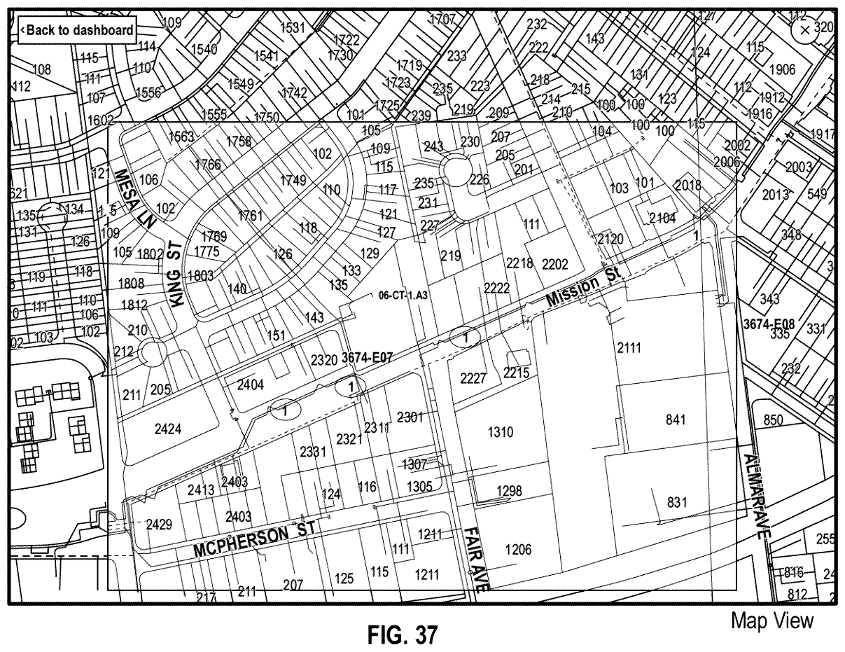

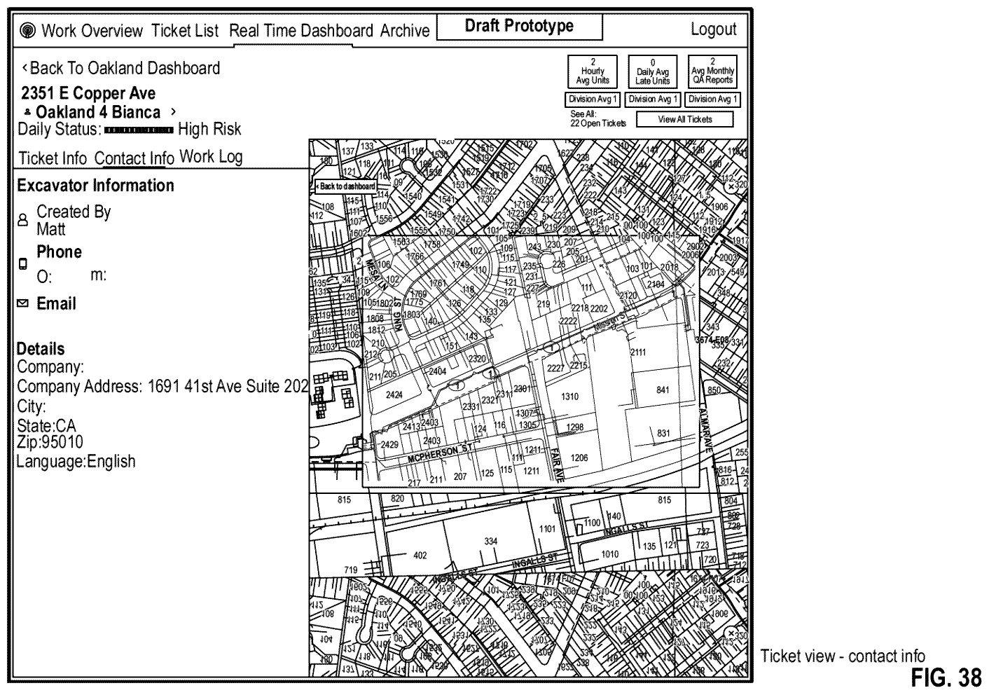

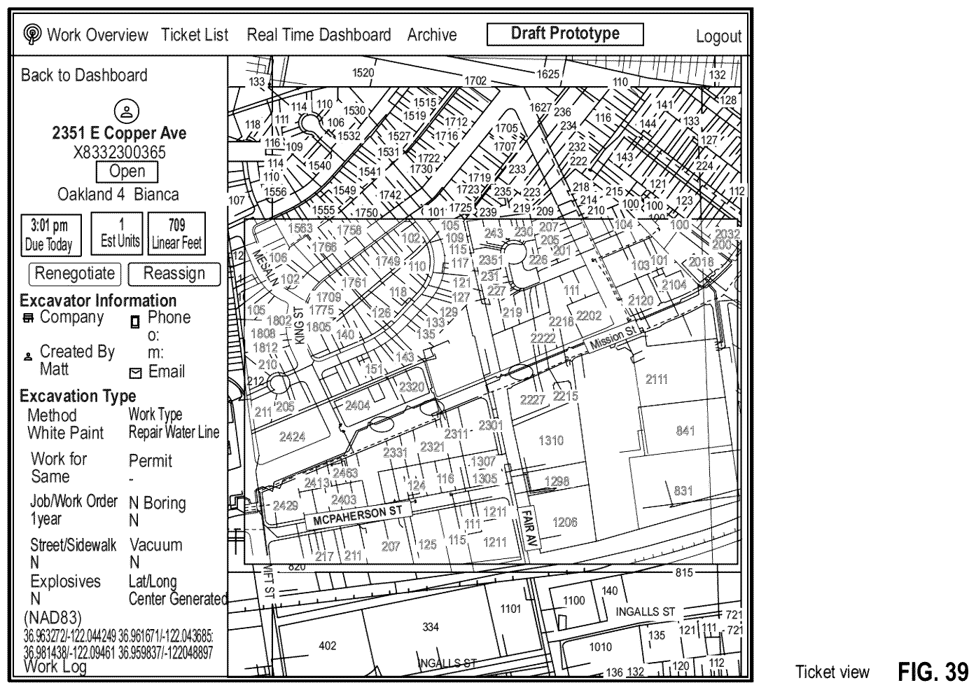

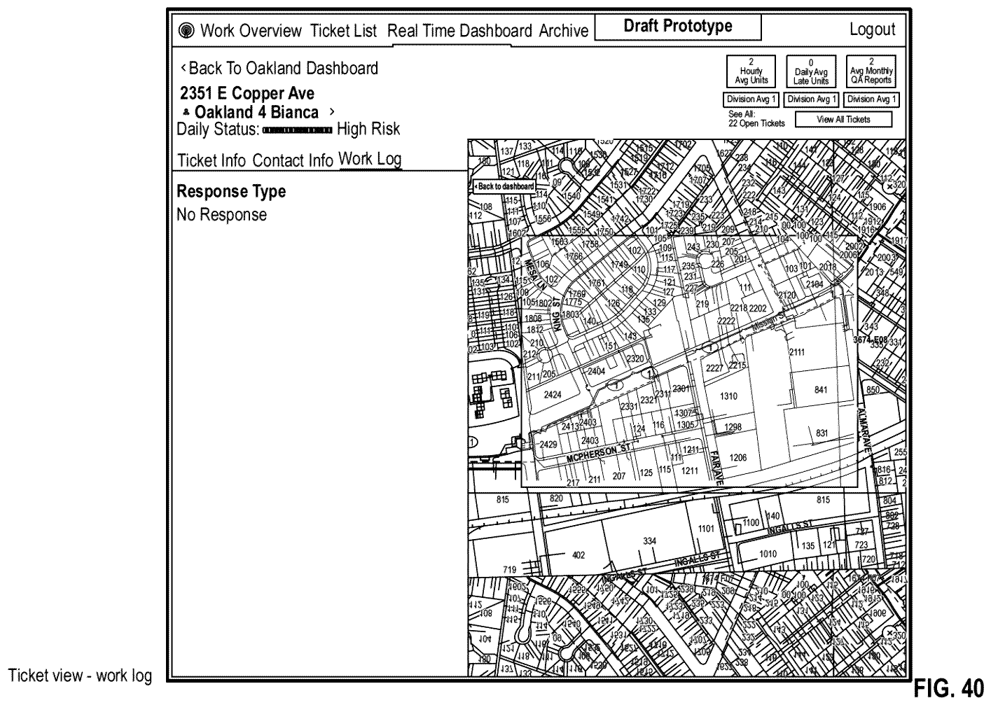

In some embodiments, the system is configured to allow the user to switch to a map view of an area as illustrated in FIG. 37, showing a map view display generated by the location and marking system according to some embodiments. Further, in some embodiments, the system is configured to display a map view and ticket information shown in the map view. For example, FIG. 38 illustrates a ticket view display generated by the location and marking system according to some embodiments; and FIGS. 39-40 illustrate ticket and map displays generated by the location and marking system according to some embodiments.

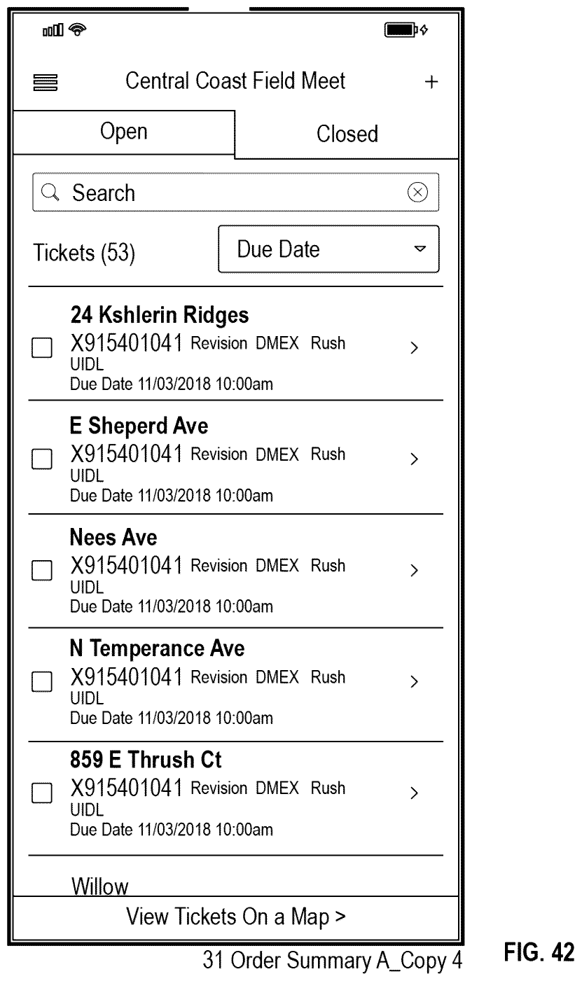

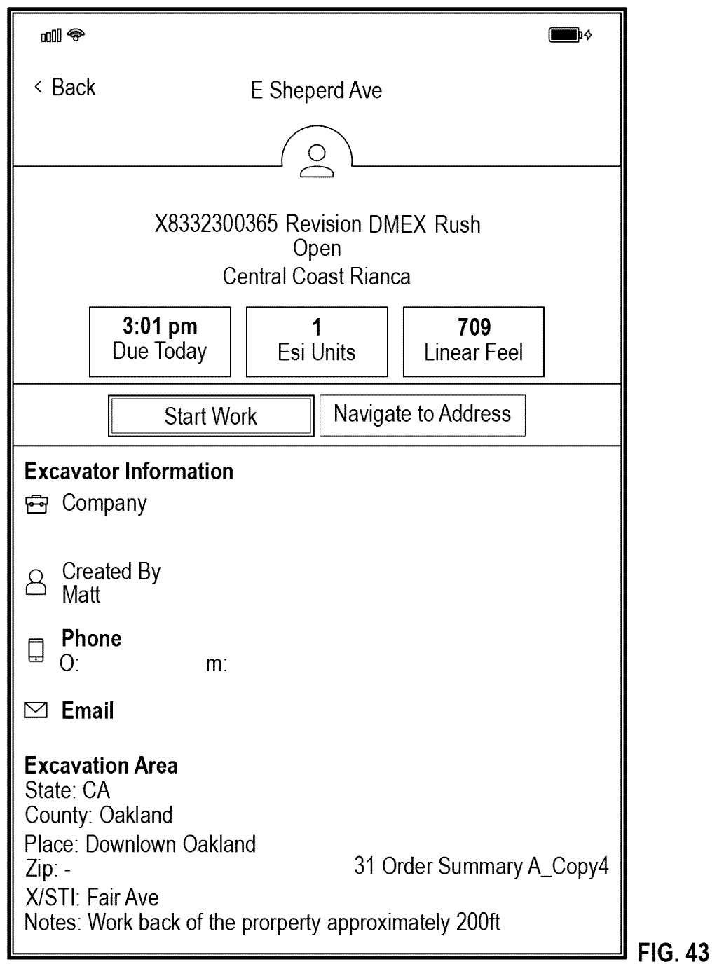

FIG. 42 illustrates an order summary display generated by the location and marking system according to some embodiments. In some embodiments, the system is configured to enable users to view an order summary of one or more tickets by filtering by one or more of due date, closed and/or open, and/or by a search for one or more tickets. In some embodiments, the system is configured to initiate a ticket detail display by clicking or accessing one or more tickets. For example, FIG. 43 illustrates a ticket and order detail display generated by the location and marking system according to some embodiments. In some embodiments, the system is configured to enable the user to start the work from the display and/or navigate to the address of the ticket.

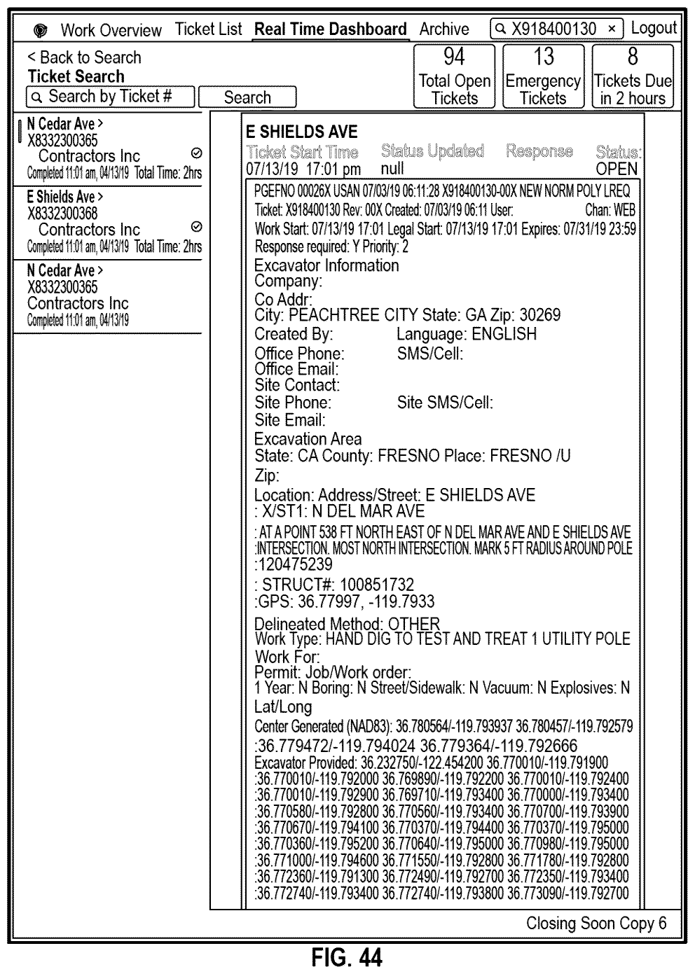

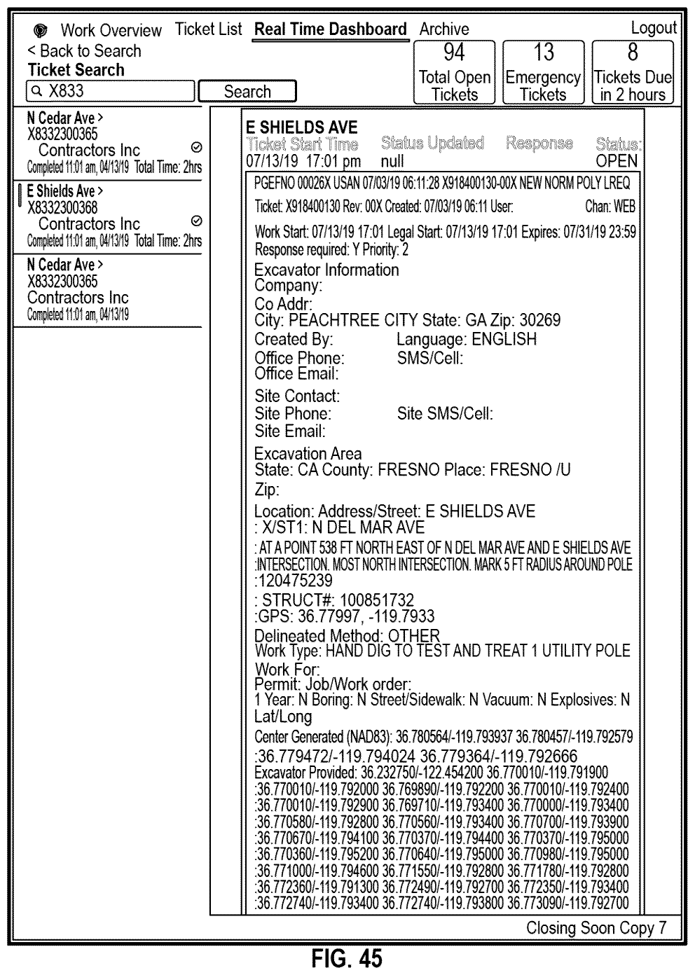

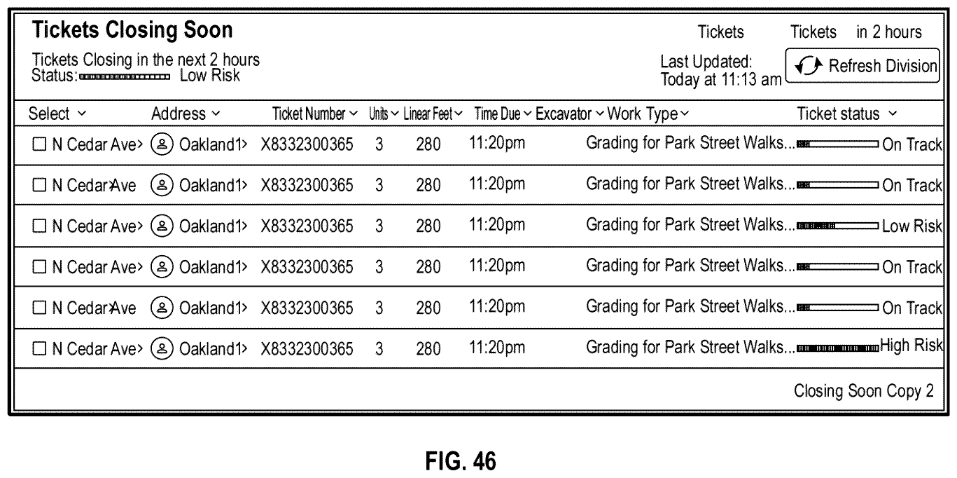

In some embodiments, the system is configured to enable users to search for closing soon tickets. For example, FIGS. 44-45 illustrate closing soon displays generated by the location and marking system according to at least one embodiment of the invention. Further, FIG. 46 illustrates a “tickets closing soon” list display generated by the location and marking system according to some embodiments.

In some embodiments, the system can be optimized for use on a mobile phone (e.g., an Apple Iphone® iOS). In some embodiments, the system is configured to enable any of the functions of the system across multiple devices substantially simultaneously (“substantially simultaneously” is defined as simultaneous execution of programs that also includes inherent process and/or network latency and/or prioritizing of computing operations). Some embodiments include improved methods for better tracking work start and stop time. Some embodiments include location-based geo-fencing. Some embodiments include auto-notifications to one or more “DIRT” teams for select field situations (e.g., when the technician closes ticket as “Excavated before marked”). Some embodiments include enhanced auto-processing of tickets where technicians do not need to work (e.g., when excavators cancel tickets).

Some embodiments include bulk actioning of tickets in mobile applications, enabled in a web interface in some embodiments, which is configured to allow a single response to multiple tickets. Some embodiments include refined reports that focus on data that is most meaningful to the business. Some embodiments include the ability to generate “break-in” tickets and work items (e.g., to track activity for internal, non-811 ticket locating work). Some embodiments include bread-crumbing of technician geo-location (to understand real time and past location for safety, performance, and work planning). Some embodiments include identification of marked delineation in-application (to clarify real work vs. 811 polygon and serve as input for unitization). In some embodiments, the system includes accessible in Maps+ (e.g., building on already-completed integration of GSRs into Maps+). Some further embodiments include tracking of specific hook-up points to support unitization and provide useful information for future locates at same site. Some embodiments include routing support for optimized driving route based on work. Apple iPhone® is a registered trademark of Apple Inc.

In some embodiments, the system includes a dig-indig-in risk model that includes a one or more AI models configured to flag 811 tickets with a higher risk of resulting in a dig-indig-in, thereby supporting investigators, such as the Dig-inDig-in Reduction Team (DIRT). In the context of a utility company, a “dig-in” refers to an incident where an excavator, either external or from the utility company itself, makes unplanned contact with an underground utility asset. In some embodiments, the system described herein can be used to prevent dig-ins in one or more of gas, electrical, water, and/or sewer conduits and related infrastructure. Such incidents can cause significant financial loss, service disruptions, and pose serious safety risks to the public and workers.

By providing advanced knowledge of risky tickets according to some embodiments herein, the system is configured can take preventative actions in addition to reactionary ones. In some embodiments, the 811 AI model is configured to identify trends and common drivers leading to risky tickets, allowing for more targeted and effective measures. In some embodiments, preventative actions may include alerts and/or outputs on the location and marking platform described above that identify the highest risk of a dig-in occurring, so that investigative teams can work to prevent an incident. In some embodiments, the system is configured to output a ranking of risky tickets to prioritize action, which may include directing a DIRT team member to take one or more actions described herein.

In some embodiments, a factor the AI model takes into consideration as an input includes excavator information. The performance history of different contractors is a significant factor in predicting dig-in risk. Certain contractors may have a higher incidence of dig-ins due to less experience, inadequate training, or poor safety practices. By analyzing excavator information, the Al model is configured to identify common culprits and assign higher risk scores to tickets involving these contractors. In some embodiments, higher insurance requirements or special financial parameters may be required from high risk contractors. Additionally, certain performance parameters may be used to evaluate high risk contractors and remedial action or termination of the relationship may result. In some embodiments, additional supervision may be mandated and charged for high risk contractors.

The following is a non-limiting example of how to train an AI model to assess risk using excavator information.

In some embodiments, the first step involves gathering historical data on excavators, including contractor names, past performance records, incident reports, and/or any available safety ratings, as non-limiting examples. This data should cover a significant period to ensure a comprehensive understanding of each contractor's performance.

In some embodiments, the collected data is cleaned to remove any inconsistencies, duplicates, or missing values. This step ensures that the dataset is accurate and reliable for training the AI model.

In some embodiments, relevant features are created from the raw data that can be used as inputs for the AI model. For example, features may include the number of past dig-ins associated with each contractor, the average severity of incidents, the frequency of safety violations, and the contractor's experience level, as non-limiting examples.

In some embodiments, the data is then labeled to indicate whether each historical ticket resulted in a dig-in (i.e., incident) or not. This binary classification (dig-in or no dig-in) serves as the target variable for the AI model in accordance with some embodiments.

In some embodiments, the dataset is then split into training and testing sets. The training set will be used to train the AI model, in accordance with some embodiments, while the testing set will be used to evaluate its performance. A suitable split ratio is 80% for training and 20% for testing.

In some embodiments, an appropriate AI model is then chosen for analyzing excavator information. In this case, a decision tree model is suitable due to its ability to handle categorical data and capture non-linear relationships.

In some embodiments, the decision tree model, or other AI model, is trained using the training dataset. The model learns to identify patterns and correlations between the input features (e.g., contractor performance metrics) and the target variable (dig-in or no dig-in).

The trained model's performance is then evaluated using the testing dataset. Suitable evaluation metrics include accuracy, precision, recall, and an F1 score. These metrics will help determine how well the model can predict the likelihood of a dig-in based on excavator information.

If necessary, in some embodiments, the model's hyperparameters are tuned to improve its performance. This step may involve adjusting parameters such as the maximum depth of the decision tree, the minimum number of samples required to split a node, and the minimum number of samples required at a leaf node.

Once the model is trained and evaluated, it is deployed within the AI-enabled 811 platform, which forms part of the system described in this disclosure. In some embodiments, at least a portion of the excavator AI model's output will then be used to assess the risk of new 811 tickets based on excavator information, providing risk scores that help prioritize actions to prevent dig-ins.

In some embodiments, a factor the AI model takes into consideration as an input includes equipment type. The type of equipment used in excavation work is directly related to the likelihood of causing a dig-in. Mechanized equipment such as backhoes, pneumatic spaders, excavators, track hoes, horizontal boring machines, and augers are more likely to cause dig-ins due to their power and precision requirements. In some embodiments, the AI model is configured to consider the type of equipment to assess the risk level accurately.

The following is a non-limiting example of how to train an AI model to assess risk using equipment type information:

In some embodiments, the first step involves gathering historical data on the types of equipment used in excavation work, including details such as equipment names, types, and specifications, as non-limiting examples. This data should cover a significant period to ensure an understanding of the equipment's impact on dig-in risk.

In some embodiments, the collected data is cleaned to remove any inconsistencies, duplicates, or missing values, ensuring that the dataset is accurate and reliable for training the AI model.

In some embodiments, relevant features are created from the raw data that can be used as inputs for the AI model. For example, features may include the frequency of use of each equipment type, the average power and precision requirements, and the historical incidence of dig-ins associated with each equipment type, as non-limiting examples.

In some embodiments, the data is then labeled to indicate whether each historical ticket resulted in a dig-in (i.e., incident) or not. This binary classification (dig-in or no dig-in) serves as the target variable for the AI model in accordance with some embodiments.

In some embodiments, the dataset is then split into training and testing sets. The training set will be used to train the AI model, in accordance with some embodiments, while the testing set will be used to evaluate its performance. A suitable split ratio is 80% for training and 20% for testing.

In some embodiments, an appropriate AI model is then chosen for analyzing equipment type information. In this case, a gradient boosting machine is suitable due to its ability to handle complex interactions between features and improve predictive accuracy.

In some embodiments, the gradient boosting machine, or other type of AI model, is trained using the training dataset. The model learns to identify patterns and correlations between the input features (e.g., equipment type metrics) and the target variable (dig-in or no dig-in).

The trained model's performance is then evaluated using the testing dataset. Suitable evaluation metrics include accuracy, precision, recall, and an F1 score. These metrics will help determine how well the model can predict the likelihood of a dig-in based on equipment type information.

If necessary, in some embodiments, the model's hyperparameters are tuned to improve its performance. This step may involve adjusting parameters such as the learning rate, the number of boosting stages, and the maximum depth of the trees.

Once the model is trained and evaluated, it is deployed within the AI-enabled 811 platform, which forms part of the system described in this disclosure. In some embodiments, at least a portion of the equipment type AI model's output will then be used to assess the risk of new 811 tickets based on equipment type information, providing risk scores that help prioritize actions to prevent dig-ins.

In some embodiments, a factor the AI model takes into consideration as an input includes type of work. Different types of work have varying levels of risk associated with them. For example, fencing work often causes dig-ins and can be treated differently due to the higher risk profile.

The following is a non-limiting example of how to train an AI model to assess risk using type of work information:

In some embodiments, the first step involves gathering historical data on the types of work performed during excavation, including details such as work descriptions, project types, and specific tasks involved, as non-limiting examples. This data should cover a significant period to ensure a thorough understanding of the work's impact on dig-in risk.

In some embodiments, the collected data is cleaned to remove any inconsistencies, duplicates, or missing values. This step ensures that the dataset is accurate and reliable for training the AI model.

In some embodiments, relevant features are created from the raw data that can be used as inputs for the AI model. For example, features may include the frequency of each type of work, the complexity of the tasks involved, and the historical incidence of dig-ins associated with each type of work, as non-limiting examples.

In some embodiments, the data is then labeled to indicate whether each historical ticket resulted in a dig-in (i.e., incident) or not. This binary classification (dig-in or no dig-in) serves as the target variable for the AI model in accordance with some embodiments.

In some embodiments, the dataset is then split into training and testing sets. The training set will be used to train the AI model, in accordance with some embodiments, while the testing set will be used to evaluate its performance. A suitable split ratio is 80% for training and 20% for testing.

In some embodiments, an appropriate AI model is then chosen for analyzing type of work information. In this case, a decision tree model is suitable due to its ability to handle categorical data and capture non-linear relationships.

In some embodiments, the decision tree model, or other AI model, is trained using the training dataset. The model learns to identify patterns and correlations between the input features (e.g., type of work metrics) and the target variable (dig-in or no dig-in), in accordance with some embodiments.

The trained model's performance is then evaluated using the testing dataset. Suitable evaluation metrics include accuracy, precision, recall, and an F1 score. These metrics will help determine how well the model can predict the likelihood of a dig-in based on type of work information.

If I necessary, in some embodiments, the model's hyperparameters are tuned to improve its performance. This step may involve adjusting parameters such as the maximum depth of the decision tree, the minimum number of samples required to split a node, and the minimum number of samples required at a leaf node.

Once the model is trained and evaluated, it is deployed within the AI-enabled 811 platform. In some embodiments, at least a portion of the type of work AI model's output will then be used to assess the risk of new 811 tickets based on type of work information, providing risk scores that help prioritize actions to prevent dig-ins.

In some embodiments, a factor the AI model takes into consideration as an input includes a ticket type. The type and renewal status of the ticket are used by the AI models as indicators of risk in accordance with some embodiments. For example, renewed tickets that are not remarked often lead to dig-ins due to degraded markings. The AI model considers whether a ticket is new, renewed, or amended to assess the risk accurately. In some embodiments, the system is configured to use the analysis from the AI model to rank multiple renewals as higher risk of dig-ins, in accordance with some embodiments, as the markings may have faded or been disturbed, for example.

In some embodiments, a factor the AI model takes into consideration as an input includes horizontal boring. Horizontal boring is a specific method of excavation that has a higher risk of causing dig-ins. This technique requires high accuracy and detailed planning to avoid underground assets. In some embodiments, the AI model specifically flags tickets involving horizontal boring and assigns a higher risk score to these tickets.

The following is a non-limiting example of how to train an AI model to assess risk using horizontal boring information:

In some embodiments, the first step includes gathering historical data on excavation projects that involved horizontal boring, including details such as project descriptions, equipment used, and specific boring techniques employed, as non-limiting examples. This data should cover a significant period (e.g., 1 to 5 years) to ensure the impact of horizontal boring on dig-in risk is understood.

In some embodiments, the collected data is cleaned to remove any inconsistencies, duplicates, or missing values. This step ensures that the dataset is accurate and reliable for training the AI model.

In some embodiments, relevant features are created from the raw data that can be used as inputs for the AI model. For example, features may include the frequency of horizontal boring projects, the depth and length of the bores, and the historical incidence of dig-ins associated with horizontal boring, as non-limiting examples.

In some embodiments, the data is then labeled to indicate whether each historical ticket involving horizontal boring resulted in a dig-in (i.e., incident) or not. This binary classification (dig-in or no dig-in) serves as the target variable for the AI model in accordance with some embodiments.

In some embodiments, the dataset is then split into training and testing sets. The training set will be used to train the AI model, in accordance with some embodiments, while the testing set will be used to evaluate its performance. A suitable split ratio is 80% for training and 20% for testing.

In some embodiments, an appropriate AI model is then chosen for analyzing horizontal boring information. In this case, a decision tree model is suitable due to its ability to handle categorical data and capture non-linear relationships.

In some embodiments, the decision tree model, or other AI model, is trained using the training dataset. The model learns to identify patterns and correlations between the input features (e.g., horizontal boring metrics) and the target variable (dig-in or no dig-in).

The trained model's performance is then evaluated using the testing dataset. Suitable evaluation metrics include accuracy, precision, recall, and an F1 score. These metrics will help determine how well the model can predict the likelihood of a dig-in based on horizontal boring information.

If necessary, in some embodiments, the model's hyperparameters are tuned to improve its performance. This step may involve adjusting parameters such as the maximum depth of the decision tree, the minimum number of samples required to split a node, and the minimum number of samples required at a leaf node.

Once the model is trained and evaluated, it is deployed within the AI-enabled 811 platform, which forms part of the system described in this disclosure. In some embodiments, at least a portion of the horizontal boring AI model's output will then be used to assess the risk of new 811 tickets based on horizontal boring information, providing risk scores that help prioritize actions to prevent dig-ins

In some embodiments, a factor the AI model takes into consideration as an input includes priority. High priority, emergency, and after-hours tickets are riskier due to the urgency and potential for rushed or less thorough work. Higher priority tickets may require immediate attention, increasing the likelihood of errors and dig-ins. In some embodiments, the AI model assesses the priority level of the ticket to determine the associated risk.

The following is a non-limiting example of how to train an Al model to assess risk using priority information.

In some embodiments, the first step involves gathering historical data on 811 tickets, including details such as the priority level of each ticket (e.g., high priority, emergency, after-hours), as non-limiting examples. This data should cover a significant period to ensure a comprehensive understanding of how priority levels impact dig-in risk.

In some embodiments, the collected data is cleaned to remove any inconsistencies, duplicates, or missing values. This step ensures that the dataset is accurate and reliable for training the AI model.

In some embodiments, relevant features are created from the raw data that can be used as inputs for the AI model. For example, features may include the frequency of high-priority tickets, the average response time, and the historical incidence of dig-ins associated with different priority levels, as non-limiting examples.

In some embodiments, the data is then labeled to indicate whether each historical ticket resulted in a dig-in (i.e., incident) or not. This binary classification (dig-in or no dig-in) serves as the target variable for the AI model in accordance with some embodiments.

In some embodiments, the dataset is then split into training and testing sets. The training set will be used to train the AI model, in accordance with some embodiments, while the testing set will be used to evaluate its performance. A suitable split ratio is 80% for training and 20% for testing.

In some embodiments, an appropriate AI model is then chosen for analyzing priority information. In this case, a gradient boosting machine is suitable due to its ability to handle complex interactions between features and improve predictive accuracy.

In some embodiments, the gradient boosting machine, or other AI model, is trained using the training dataset. The model learns to identify patterns and correlations between the input features (e.g., priority metrics) and the target variable (dig-in or no dig-in).

The trained model's performance is then evaluated using the testing dataset. Suitable evaluation metrics include accuracy, precision, recall, and an F1 score. These metrics will help determine how well the model can predict the likelihood of a dig-in based on priority information.

If necessary, in some embodiments, the model's hyperparameters are tuned to improve its performance. This step may involve adjusting parameters such as the learning rate, the number of boosting stages, and the maximum depth of the trees.

Once the model is trained and evaluated, it is deployed within the AI-enabled 811 platform. In some embodiments, at least a portion of the priority AI model's output will then be used to assess the risk of new 811 tickets based on priority information, providing risk scores that help prioritize actions to prevent dig-ins.

The system also receives GIS data, which includes pipe material type and the count of underground GIS assets such as gas distribution (GD), gas transmission (GT), electric distribution (ED) mains and services, and fiber optics. In some embodiments, the type of pipe material is considered, as plastics are more likely to be damaged than steel. The count of underground assets provides an indication of the density and complexity of the underground infrastructure. The AI model uses this information to assess the risk of a dig-in more accurately.

The following is a non-limiting example of how to train an AI model to assess risk using GIS data.

In some embodiments, the first step involves gathering historical GIS data, which includes details such as pipe material type and/or the count of underground GIS assets such as gas distribution (GD), gas transmission (GT), electric distribution (ED) mains and services, and fiber optics, as non-limiting examples, over a significant period of time.

In some embodiments, the collected data is cleaned to remove any inconsistencies, duplicates, or missing values. This step ensures that the dataset is accurate and reliable for training the AI model.

In some embodiments, relevant features are created from the raw data that can be used as inputs for the AI model. For example, features may include the type of pipe material, the count of underground assets, the density of the underground infrastructure, and the historical incidence of dig-ins associated with different GIS attributes, as non-limiting examples.

In some embodiments, the data is then labeled to indicate whether each historical ticket resulted in a dig-in (i.e., incident) or not. This binary classification (dig-in or no dig-in) serves as the target variable for the AI model in accordance with some embodiments.

In some embodiments, the dataset is then split into training and testing sets. The training set will be used to train the AI model, in accordance with some embodiments, while the testing set will be used to evaluate its performance. A suitable split ratio is 80% for training and 20% for testing.

In some embodiments, an appropriate AI model is then chosen for analyzing GIS data. In this case, a neural network is suitable due to its ability to handle large volumes of spatial data and identify intricate patterns.

In some embodiments, the neural network, or other AI model, is trained using the training dataset. The model learns to identify patterns and correlations between the input features (e.g., GIS metrics) and the target variable (dig-in or no dig-in).

The trained model's performance is then evaluated using the testing dataset. Suitable evaluation metrics include accuracy, precision, recall, and an F1 score. These metrics will help determine how well the model can predict the likelihood of a dig-in based on GIS data.

If necessary, in some embodiments, the model's hyperparameters are tuned to improve its performance. This step may involve adjusting parameters such as the learning rate, the number of layers, and the number of neurons per layer.

Once the model is trained and evaluated, it is deployed within the AI-enabled 811 platform, which forms part of the system described in this disclosure. In some embodiments, at least a portion of the GIS data AI model's output will then be used to assess the risk of new 811 tickets based on GIS data, providing risk scores that help prioritize actions to prevent dig-ins.

Using one or more of the afore mentioned factors as inputs, in some embodiments, the system is configured to identify and rank risky 811 tickets, where “risky” refers to a group where a ticket with the highest probability of incident is listed at the top (e.g., position 1), followed by a descending order of tickets with highest to lowest probability of incident. In some embodiments, the processor is configured by instructions stored on non-transitory computer readable media to execute instructions to receive 811 ticket data. In some embodiments, the 811 ticket data includes one or more factors described above, such as excavator information, type of equipment, type of work, ticket type, horizontal boring, priority, the number of times the ticket has been renewed, GIS data, including pipe material type and/or the count of underground GIS assets such as gas distribution (GD), gas transmission (GT), electric distribution (ED) mains and services, and fiber optics, as well as any other factor described herein.

In some embodiments, one or more of the 811 ticket data is fed as input into the one or more AI models. The AI-enabled system may include various types of AI models, including but not limited to, decision trees, random forests, gradient boosting machines (e.g., XGBoost), and neural networks. Each model type has its strengths and is selected based on the specific characteristics of the data and the desired outcomes. For instance, decision trees and random forests are effective for handling categorical data and capturing non-linear relationships, while gradient boosting machines are known for their high predictive accuracy and ability to handle imbalanced datasets. Neural networks, particularly deep learning models, are suitable for capturing complex patterns in large datasets, in accordance with some embodiments.

In some embodiments, specific models are used for each factor to enhance the accuracy of the risk assessment. For example, a decision tree model may be used to analyze excavator information, while a gradient boosting machine may be employed to evaluate the type of equipment and its associated risk. A neural network could be utilized to process GIS data, given its ability to handle large volumes of spatial data and identify intricate patterns.

Based on this analysis, the system generates a risk score for each 811 ticket, ranking the tickets according to their likelihood of resulting in a dig-in. The ranked list of risky tickets is displayed through a graphical user interface, enabling DIRT investigators to prioritize their actions. The system also provides alerts and notifications to relevant stakeholders, such as email alerts or field visit recommendations, based on the risk scores.

As a non-limiting example, a training dataset included 6M tickets of type NEW and RNEW spanning 2020-2023. Of these tickets, 3617 had dig-ins (i.e., 0.06%). The training dataset was further minimized by selecting only the highest renewed ticket. For example, a ticket could be renewed 20 times and be listed in the dataset 20 times. However, because the ticket information is always the same, 19 instances were removed and only the 20th renewal was included. Some manual entry of ticket numbers in the dig-in data led to errors and inhibited a full join. Thus, the final model input dataset included 3.4M tickets and 3383 dig-ins. Feature engineering performed including target encoding “pge_excavator” and extracting common words from “work_type.” An XGB model was trained on 31 features using the default loss metric for classification, log loss.

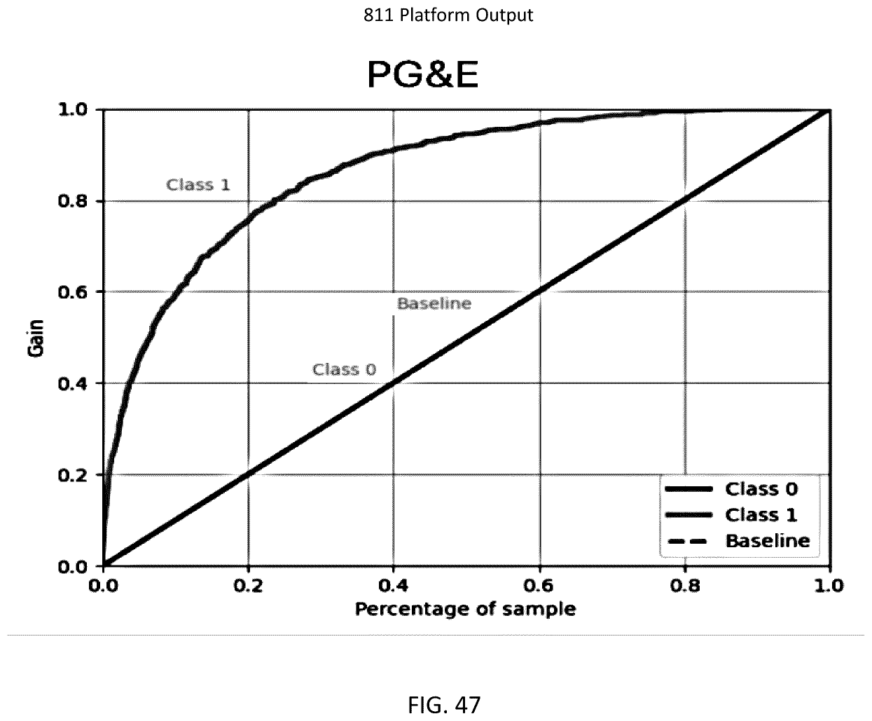

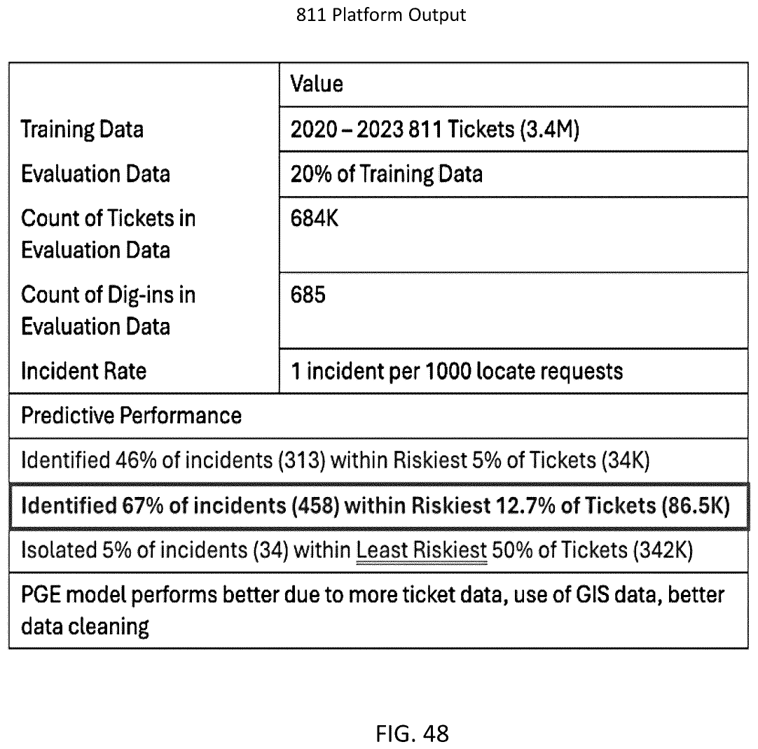

FIGS. 47 and 48 show the results for this non-limiting example according to some embodiments. With reference to FIG. 47, the x-axis represents the percentage of the total sample (811 tickets) that are flagged as positive (high-risk) by the model. For example, if the model flags 10% of the tickets as high-risk, this point would be at 10% on the x-axis. The y-axis represents the percentage of true positive instances (actual dig-ins) that are identified within the flagged sample. For example, if 50% of the actual dig-ins are identified within the top 10% of the flagged tickets, this point would be at 50% on the y-axis. The cumulative gains curve helps assess the model's ability to concentrate true positives within the top-ranked predictions. A steeper curve indicates better model performance, as it shows that a higher percentage of true positives are identified within a smaller percentage of the flagged sample, the chart shows that 67% of true dig-ins were identified within 12.7% of the riskiest tickets flagged by the AI model. This means that the model was able to concentrate a significant portion of the actual dig-ins within a relatively small subset of the flagged tickets, demonstrating its effectiveness in identifying high-risk tickets.

FIG. 48 depicts key performance metrics for the system's AI model(s) in identifying risky 811 tickets in accordance with some embodiments. The AI model flagged 12.7% of the total sample (811 tickets) as high-risk, which is the proportion of tickets that the model considers to be at high risk of resulting in a dig-in. In some embodiments, in the output of the AI model, 67% of true dig-ins were identified in 12.7% of the riskiest tickets for the system model, indicating that the model is effective in concentrating a significant portion of true dig-ins within a relatively small subset of flagged tickets.

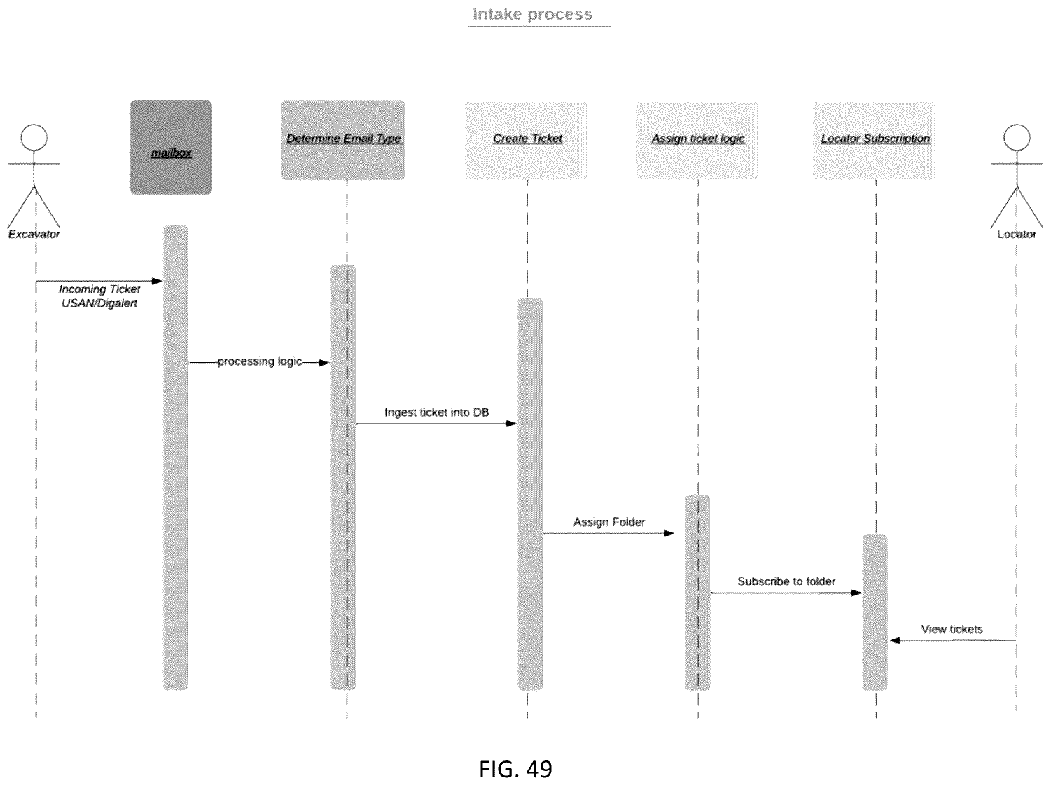

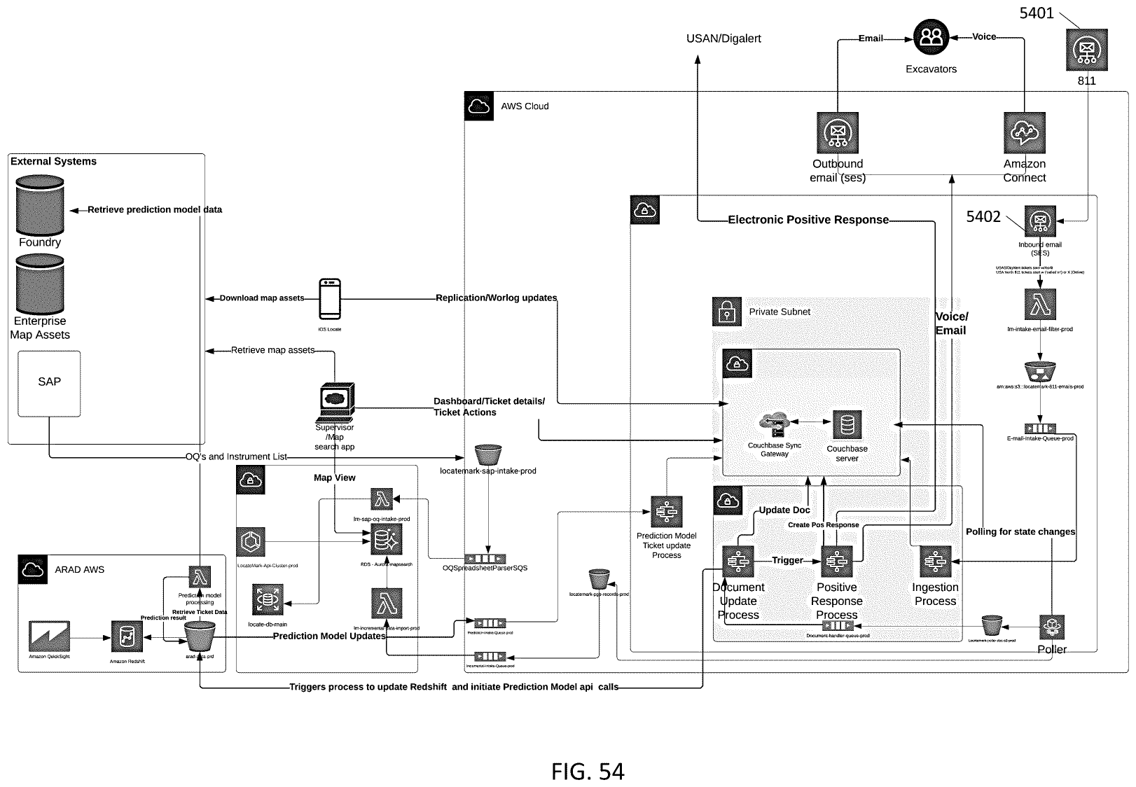

FIG. 49 shows steps implemented by a ticket management platform portion of the system according to some embodiments. In some embodiments, the ticket management platform is configured for execution and ingestion and/or assignment of an 811 request. In some embodiments, the system is configured to receive tickets 5401 (FIG. 54) from one or more 811 request providers, such as Underground Service Alert of Northern California (USAN) and Underground Service Alert of Southern California (DigAlert) as non-limiting examples. In some embodiments, these tickets are generated and delivered by these services through a communication notification (e.g., email) and contain various information about a work request. In some embodiments, the system is configured to analyze the ticket information contained in the email 5402 and automatically assign the ticket to a field technician. In some embodiments, the system is configured to automatically generate a folder identification (ID) and/or associate the folder ID with the ticket. In some embodiments, the system is configured to enable the field technicians to subscribe to the generated folders through a computing device such as a smart device, mobile phone, tablet or the like. Advantageously, the system is configured to enable a user to download only the folder to which they are subscribed for access when the user (e.g., field technician) is offline or in an area with limited data reception. This saves computer resources as the user's smart device can intermittently poll the host server for updates to ticket automatically so that the user has the latest information when they arrive at the site, but data is transferred for only the folder to which they are subscribed as opposed to receiving data for all tickets according to some embodiments.

A computer implemented method for the ticket ingestion platform begins with the utility receiving the email as described above. In some embodiments, the emails contain the details of the ticket as well as attachments that identify the boundary of the dig site. In some embodiments, the emails are the input into the ticket ingestion platform. In some embodiments, the system is configured to interface with utility software vendor systems, such as Newtin and Pelican, for example, which support the 811 “call before you dig” platforms. Some embodiments include a step of the system determining an email type. Both USAN/Digalert send emails that represent a ticket, and emails that provide an end of day audit of tickets processed for the day. In some embodiments, the system is configured to determine if the ticket in the incoming email needs to be processed.

Some embodiments include a step of creating a ticket. In some embodiments, creating a ticket includes converting the incoming email to a format for processing and/or storage by the ticket ingestion platform. In some embodiments, this process involves converting the incoming email, which is in a first format, into a format ready to be stored in the platform. In some embodiments, the process includes generating a new structure as a second format that includes the ticket information so that users (e.g., supervisors, field technicians) have a consistent ticket view regardless of the email source and/or email format. In some embodiments, the tickets are assigned a unique folder ID as they are received. In some embodiments, the system is configured to use the folder ID to organize tickets into workflows for individual technicians and/or specialized teams. In some embodiments, the system is configured to generate assignments for the tickets based on one or more of key words in the ticket, defined geographical boundaries associated with the ticket (e.g., Regcodes and/or member codes), and platform defined geographical boundaries. In some embodiments, the system is configured to enable technicians (e.g., locators or any other authorized users) to respond to the tickets in their area of responsibility, which may be defined in the system by a geographical area and/or technician qualification (e.g., qualified electrical worker, designated standby, etc.) in some non-limiting examples.

As described above, in some embodiments, the system is configured to enable a user to subscribe to folders based on relevant work they are responsible for performing and/or monitoring. In some embodiments, ticket data within a user's subscribed folder(s) is kept in kept in-sync in a local database within the application that maintains parity with its subset of relevant documents, which is used to enable “Offline-first” capabilities. In some embodiments, “Offline-first” includes the system's utilization of locally available data from intermittent and/or requested downloads that allow for core feature and work to be performed with this preloaded information and synchronized when connectivity is reestablished. In some embodiments, the system is configured to download relevant map data (PG&E map and asset data) pre-loaded in a similar way to enable work to be performed in low or no network areas.

In some embodiments, the platform includes a locate application configured to preload map and/or asset data as described above. In some embodiments, the locate application is configured to interface with a document-oriented database (e.g., Couchbase SDK) to enable a user to subscribe to a folder. Ticket data (along with asset/map data) is available offline, and user can interact with all core features. In some embodiments, the system is configured to automatically generate a polygon shape 5102 around the work area on the map based on the analysis of the email 5101. In some embodiments, the locate application is configured to store user authored data and/or attachments locally on the user device and synchronize automatically when in improved network settings. In some embodiments, the locate application is configured to enable the user to view tickets relevant to them, and respond by creating worklogs. In some embodiments, the worklogs are configured to enable a user to append photos, append notes, document hookup points (geospatial), document communication and agreements with excavators, and/or follow one or more responses, which may include unique user flows and checks.

Once worklogs are processed by server side and are treated as transactions against their parent ticket, the system is configured to change the ticket state depending on a user's response, which may include “facilities marked” as a non-limiting example according to some embodiments. In some embodiments, the system is configured to retrieve gas service records to aid in locating assets. In some embodiments, the system is configured to highlight one or more fields for quick reference. In some embodiments, the system is configured to enable a user to move tickets (e.g., via a ticket action) into a different folder and/or division to put the ticket in a different workflow. In some embodiments, the system will generate a transaction record for ticket reassignment and/or modification.

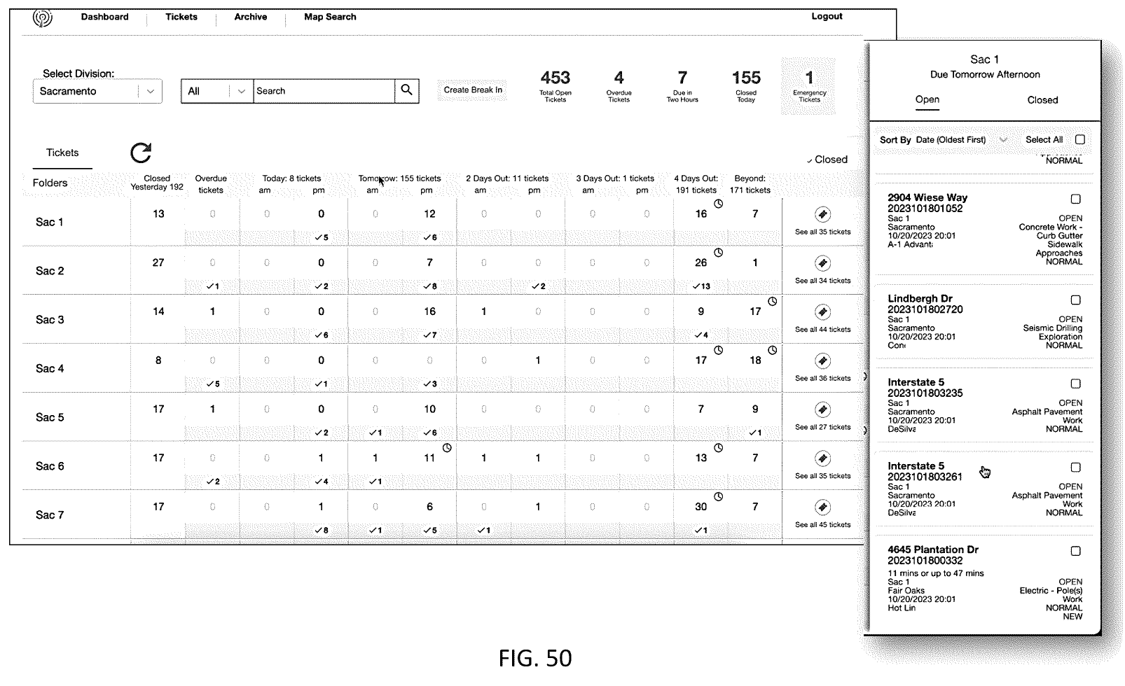

FIG. 50 illustrates a supervisor dashboard graphical user interface according to some embodiments. In some embodiments, the dashboard includes a division level (e.g., Sacramento) view across all a given division's folders (e.g., Sac 1, Sac 2, etc.) and provides a high-level view of ticket counts for each folder, categorized by their due dates and statuses. In some embodiments, interaction with one or more cells generates a list and enables drill down functionality. In some embodiments, the dashboard is configured enable a user to select one or more tickets to respond, move, and/or cancel. Some embodiments enable a user to search by ticket category and/or keyword.

In some embodiments, the dashboard includes statistical summaries such as division-level stats which are displayed next to the search box in this non-limiting example. Statistical summaries may include fields such as overdue tickets, tickets due (e.g., in under 2 hrs), tickets closed (today), and/or open emergency tickets. In some embodiments, selection of a summary executes a link to a drill down view. In circumstances where documentable work needs to be captured by a technician that has no ticket, the system is configured to enable a user to create a Break In ticket that allows for a technician to respond to the Break In ticket and document their work according to some embodiments.

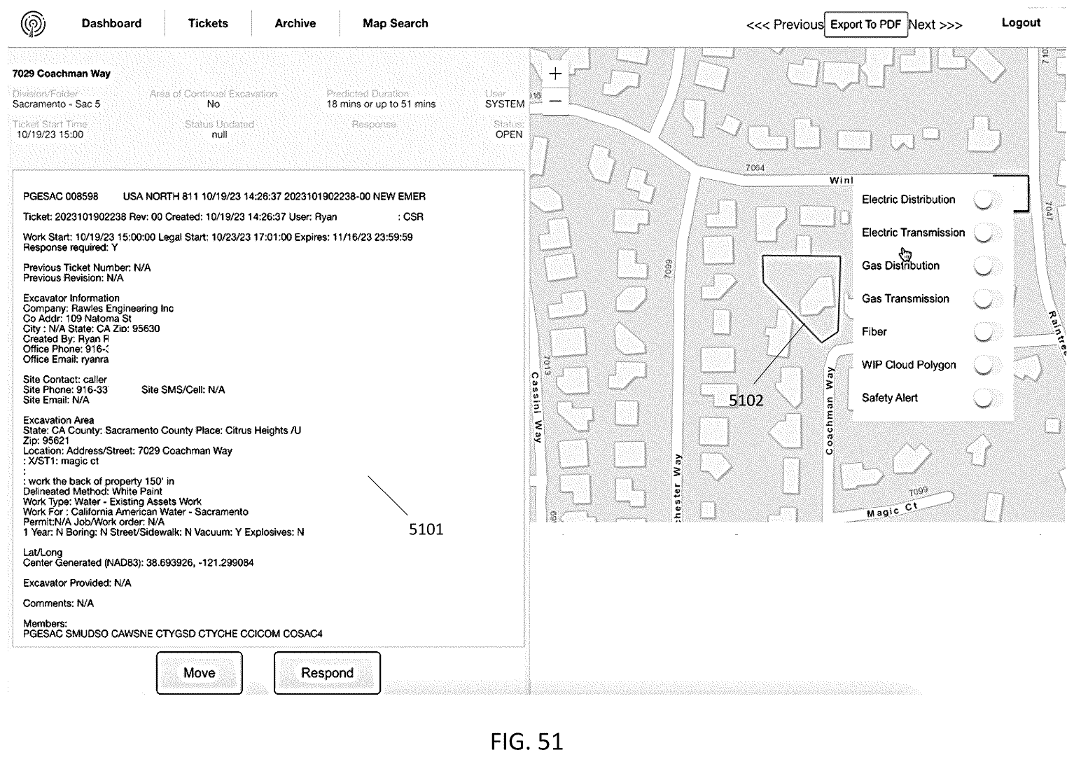

After selecting a ticket, the system is configured to generate a ticket detail GUI. FIG. 51 shows a ticket detail GUI according to some embodiments. In some embodiments, the ticket detail GUI is configured to display 811 ticket details received from the email 5102. In some embodiments, the ticket detail GUI includes a map view of the boundary of the rendered ticket. In some embodiments, the map includes on or more toggles for asset layer to view alongside boundary overlays generated by the system. In some embodiments, worklogs, ticket action (e.g., move history) and positive responses are displayed. In some embodiments, photos, attachments, referenced worklogs, and other information are also displayed, as well as the option to export to a different format (e.g., PDF).

Referring back to FIG. 50, in some embodiments, the GUI includes a ticket list view as shown to the right. In some embodiments, the ticket list view provides a drill down capability at a division/folder level, but with a ticket representing a row, thereby providing more details about groups of tickets at once. In some embodiments, the list view includes a map toggle configured to generate ticket list items as points on a map. In some embodiments, details and/or filter criteria can be set to display on or more of time range, technician ID, ticket city, ticket status, response type, and ticket priority.

Using the ticket ID, the system enables a user to look up the entire audit history of a ticket, including incremental database document versions captured throughout the lifecycle of various records. In some embodiments, a map search function enables a user to input one or more of ticket status, data range, and location for criteria to filter the display. In some embodiments, location can be the result of moving the map within the viewport and/or defining the view using user defined shapes. In some embodiments, the system is configured to enable the user to create the shapes around an area, which may include markers such as a polygon 5102 (FIG. 51), circle, lines with buffers (FIG. 4), and the like. In some embodiments, search results query a relational database service (e.g., Amazon® RDS) which has geospatial indexing and the results are displayed as markers on the map. In some embodiments, markers can be clicked for details of the ticket's status, and a link to a ticket detail is available in some embodiments. In some embodiments, the GUI includes a results table populated with a row for each ticket rendered, which can be toggled. Tickets may further be filter by addresses and/or ticket IDs.

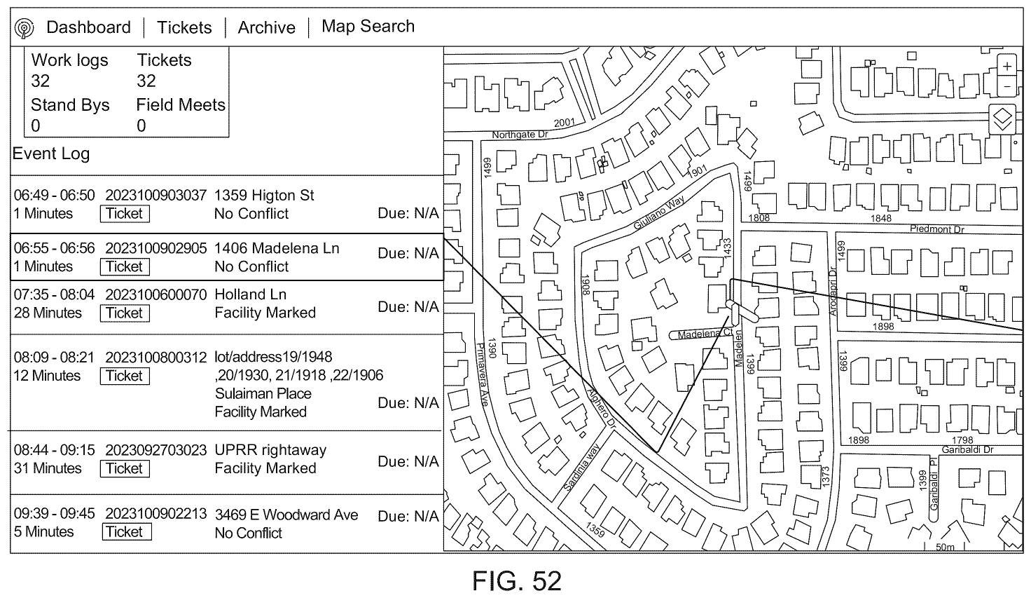

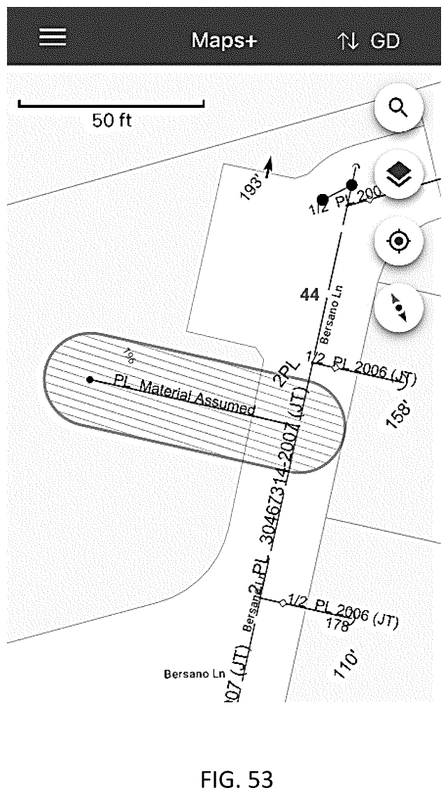

In some embodiments, the system is configured to send a user's location, and the user's location can be used to center the map on the user's location and display relevant ticket information for that area. In some embodiments, the system is configured to enable a user such as a supervisor to review a particular technicians work and or location for a given day, which may include their trip details and/or key actions as they perform their work. Advantageously, the system is configured to track a user's movement throughout a time period which gives valuable insight as to where the user needed to go to complete a given task. FIG. 52 shows user movement tracking overlaid on a map for a given work order according to some embodiments. FIG. 53 shows an output on the location and marking GUI identifying a high-risk dig-in location and area boundary as determined by the one or more AI models discussed above, in accordance with some embodiments.

FIG. 54 shows a non-limiting system architecture for the ticket management platform according to some embodiments. As outlined in FIG. 49, the process starts when an “811 call” 5401 generates an email 5402 comprising the 811 ticket information. In some embodiments, the system is configured to support one or more vendors which include Newtin for Digalert and Pelican for USAN (Unique System Assignment Number) in this non-limiting example. As described above, in some embodiments, the incoming emails include details of the ticket as well as one or more attachments that identify the boundary of the dig site. In some embodiments, the system is configured to determine the email type. Both USAN/Digalert send emails that represent a ticket and emails that provide an end of day audit of tickets processed for the day. In some embodiments, the system is configured to route tickets and/or identify if incoming email is a ticket that needs to be processed or an audit email that is handled by another process.

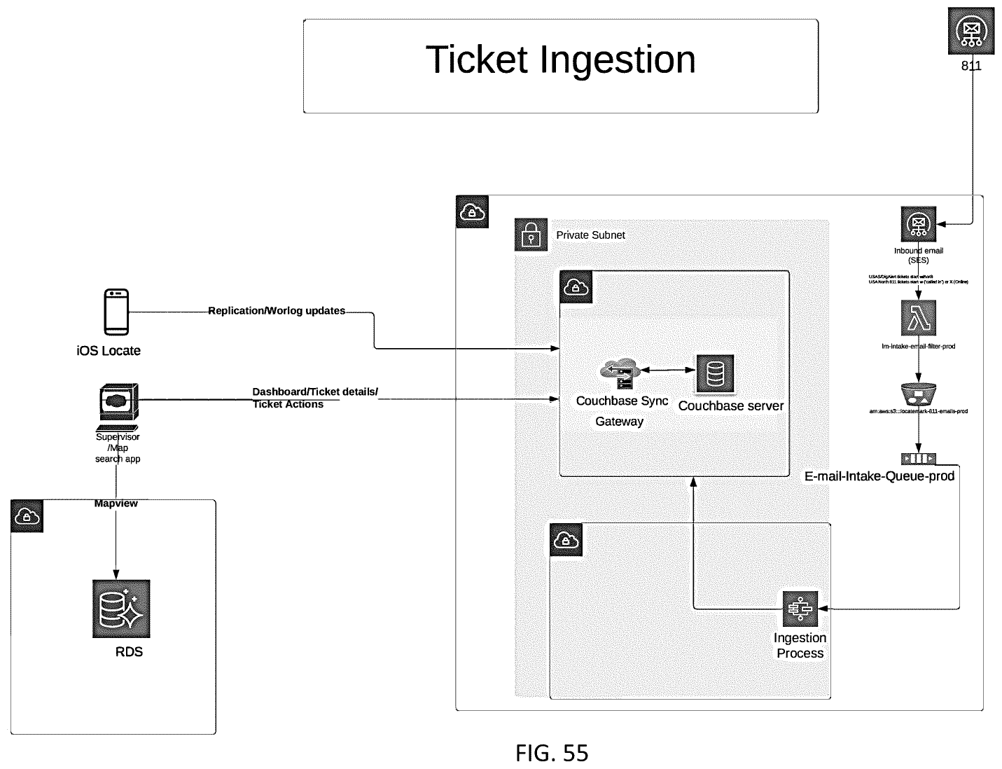

FIG. 55 shows the ticket ingestion portion of the system architecture of FIG. 54 according to some embodiments. In some embodiments, during the ingestion process, the system is configured to convert the incoming email into a format ready to be stored in the ticket management database. This includes a step to normalize and/or alter the structure of ticket data for viewing the ticket in the iOS and web applications described above. As tickets are ingested, they are evaluated and tagged with a unique “folder” id. A folder is one way tickets are tagged to organize tickets into workflows for individual technicians and specialized teams in some embodiments. In some embodiments, assignment is automatically executed based on business logic such as key words in the ticket, vendor-defined geographical boundaries (e.g., Regcodes and member codes) as well as internally-defined geographical boundaries.

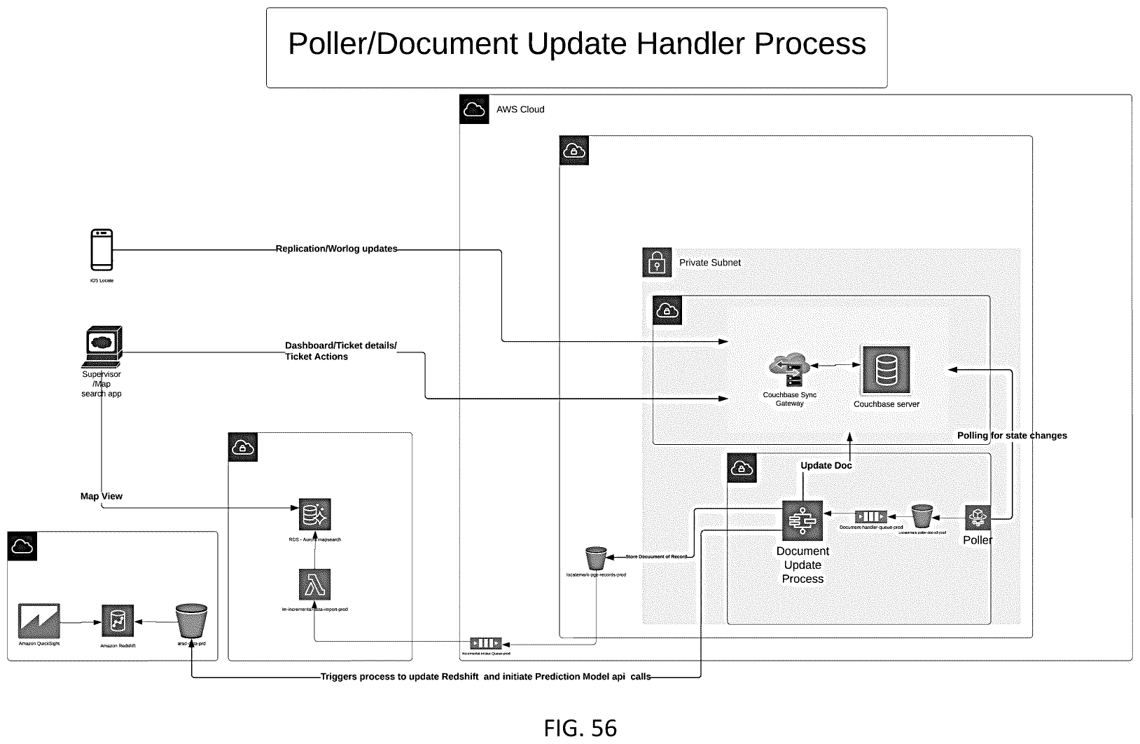

FIG. 56 shows the poller and document update handler process portion of the system architecture of FIG. 54 according to some embodiments. In some embodiments, a server that is subscribed to all document updates in a NoSQL database management system that combines the capabilities of a document-oriented database with the performance and scalability of a distributed key-value store (e.g., Couchbase®). As document updates occur, the poller will send document data to the Document Update Handler step function, which is called with every document update in Couchbase®. Depending on the document and if the document is a pending transaction, the document is processed by one or more modules that include a reporting export, a document update handler, a ticket action update handler, and a worklog update handler. In some embodiments, as an initial step, the reporting exporter stores documents in one or more S3 record buckets as well as collates documents to be exported for analysis using software to store and query large volumes of structured data using standard SQL queries (e.g., Redshift AWS®).

In some embodiments, the document update handler includes a step function choice step which sends worklog documents to the worklog update handler and ticket action documents (used for reopening and moving tickets) to the ticket action update handler. In some embodiments, the ticket action update handler is configured to process the ticket action documents as transactions against the tickets the ticket action documents references. In some embodiments, the ticket action update handler executes one or more steps that include confirming the transaction is still valid by checking if has a status: successful flag. If the transaction is successful then the transaction exits with no-op. Another step includes to evaluate the referenced action and tickets and attempt to apply that change to the ticket documents. The ticket action update handler may further append a status (e.g., success/failed flag) value to the ticket action to conclude the transaction.

In some embodiments, the worklog update handler is configured to process a worklog document as transactions against the ticket the worklog document references, and may also trigger the positive response flow if relevant. In some embodiments, the worklog update handler will confirm the transaction is still valid by checking if the transaction has a status: successful flag. If transaction does, then worklog update handler exits with no-op, which includes terminating without performing any operations or action. In some embodiments, an execution step includes fetching a parent ticket document and applying the worklog's response to the parent ticket. In some embodiments, to account for out-of-chronological-order processing of worklogs, state changes are applied retroactively if they are the latest, based upon their authored time. If certain criteria are met (such as excavation near a critical facility), a field meet or standby ticket is created automatically. The new ticket references the originating ticket and is assigned to the same folder to be visible immediately to the technician who worked on the originating ticket. If the ticket's state change as a result of this transaction is associated with triggering a positive response, then the relevant components of the worklog, ticket, and excavator contact information are sent to the positive response step function.

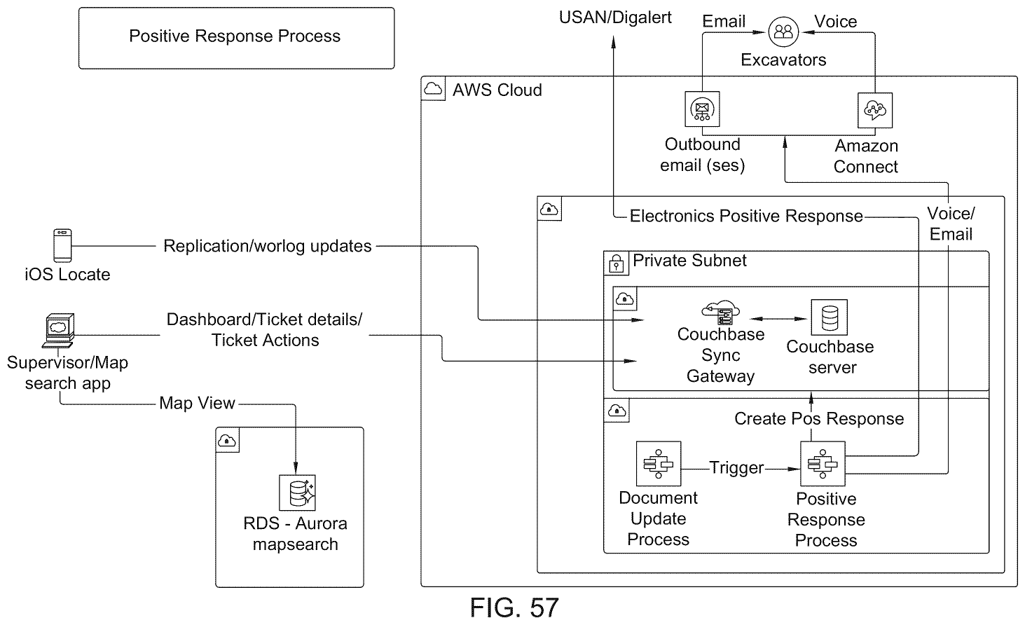

FIG. 57 shows the positive response step function process portion of the system architecture of FIG. 54 according to some embodiments. In some embodiments, the positive response step function evaluates incoming positive response information, determines if email or phone contact will be used for a direct response to the excavator, and/or determines the 811 call center and vendor. In some embodiments, the positive response is sent to a queue associated with the particular integration (e.g., either USAN or DigAlert). In some embodiments, the positive response step function evaluates whether phone or email was chosen and will send the transaction to either the email contact or phone contact step.

In some embodiments, the email contact lambda is used to generate the email that will be sent to the excavator who opened the 811 ticket. Once the email has been created, it sends the email and creates a positive response document in Couchbase®, for example, that is used to track the contact attempt. After an elapsed time, the check email step triggers and evaluates the outcome of the email attempt and updates the positive response document in Couchbase®. Any reference to Couchbase® as used in this non-limiting example is a general reference to any suitable and scalable database platform designed for high-performance and flexible data storage, retrieval, and real-time analytics.

In some embodiments, the phone contact lambda is used to initiate the phone call to the person who submitted the 811 ticket. Once the phone call has been initiated, a ContactId from a cloud-based contact center service (e.g., Amazon Connect®) is tracked to follow up on the status of the call. In some embodiments, a positive response document is created in Couchbase® to track the outcome of the contact. After an elapsed time, in some embodiments, the check phone step triggers and evaluates the outcome of the phone call attempt and updates the positive response document in Couchbase®.

In some embodiments, the system includes electronic positive response (EPR) integrations. In some embodiments, a positive response includes communication from a utility operator indicating the status of the requested excavation area. In some embodiments, the positive response informs the excavator whether there are underground utilities in the proposed excavation site and may include details such as the type of utilities, their location, and any specific requirements or precautions. In some embodiments, the EPR includes a positive response application programming interface (API), which may include an application hosted on AWS Fargate®, for example, which integrates with 811 call centers that utilize the Newtin ticket management system. The application (App) consumes positive response messages on its dedicated SQS queue and opens connections to the respective Newtin TCP server and when connected, attempts to send positive responses to the system. In some embodiments, the EPR includes a Pelican positive response that is configured to take messages from its SQS queue (delivered from the Positive Response step function) to handle delivering Electronic Positive Responses (EPR) to the Pelican vendor application via a REST API with a JSON payload.

In some embodiments, the system includes a lambda architecture which includes a design pattern for processing large-scale data. In some embodiments, the system includes an incremental lambda. In some embodiments, the lambda architecture includes three layers: the batch layer, the serving layer, and the speed layer. The batch layer is responsible for handling historical data through batch processing, while the speed layer deals with real-time data using stream processing. In some embodiments, the serving layer provides a unified view of the processed data. The Extract, Transform, Load (ETL) lambda executed by the system is responsible for transforming live Couchbase data updates into RDS tables to be available for reporting, geo-querying, and graphical queries. As records are updated in the records S3 bucket, each event is placed on the incremental lambda's queue to be ingested according to some embodiments.

In some embodiments, the system includes Operational Qualification (OQ) and the management of instrument calibration data which includes SAP (Systems, Applications, and Products) software. In some embodiments, these integrations are configured to maintain parity with relevant operator qualification information and associated instrument calibration data that is used to confirm that technicians are authorized to perform their work and their instruments are valid. In some embodiments, external vendors intermittently sends a flatfile (csv/json) to a ‘drop-zone’ S3 bucket in the locate account. When a document lands in S3, an event is put on a queue and processed by a lambda that ingests and updates the data into RDS to be made available to the (iOS) application to evaluate according to some embodiments.

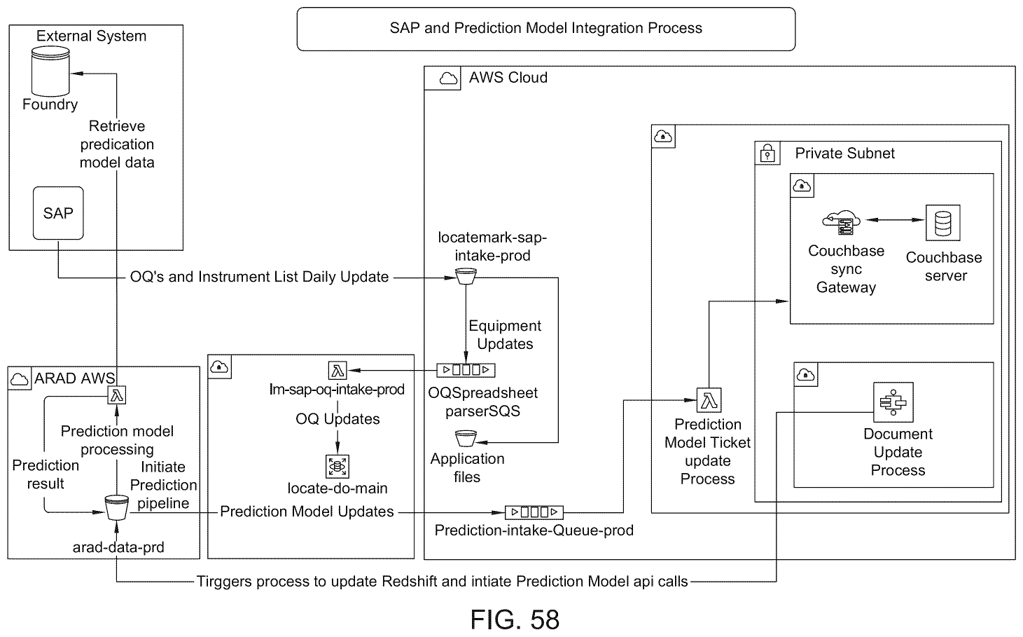

In some embodiments, as new documents are made available to be ingested into the analysis software (e.g., Redshift), the incoming ticket data is processed in parallel by a foundry-hosted machine learning model that evaluates components in the tickets such as their geometry and cross-references them with the utilities assets in that location to determine a dig-in risk as well as time complexity. FIG. 58 shows the prediction model portion of the system architecture of FIG. 54 according to some embodiments. Duration predictions and dig-in risk model predictions are made and sent to a queue to be processed by the append prediction lambda, which takes the incoming predictions and appends them to their ticket in Couchbase. This data is made available immediately at the very beginning of the lifecycle of a ticket for supervisors/technicians to have an additional layer of intelligence around the new ticket. FIG

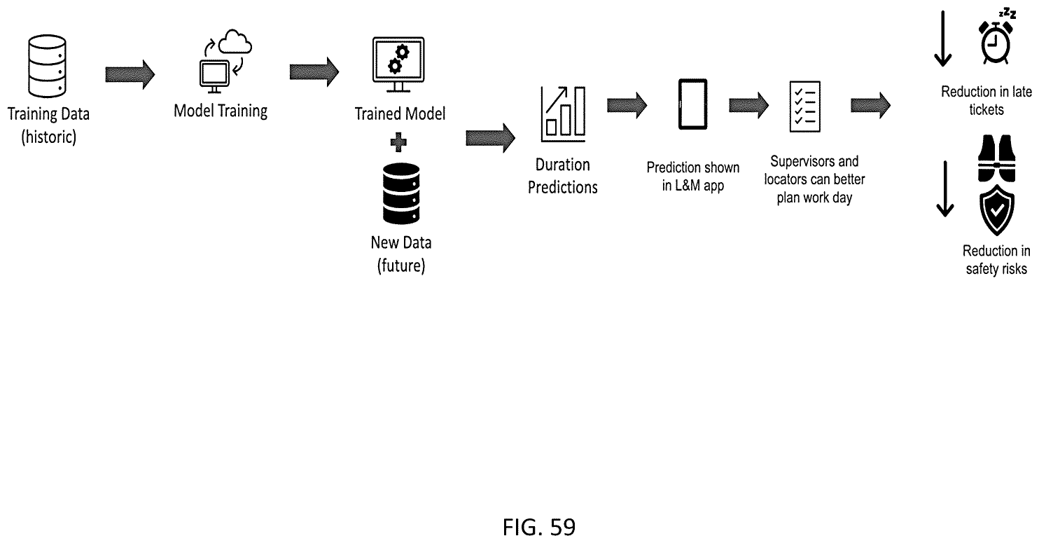

FIG. 59 shows a process flow for a duration predictions artificial intelligence (AI) model according to some embodiments. In some embodiments, in this non-limiting example, the duration model takes in one or more of 17 features from the Locate and Mark (L&M) 811 ticket and GIS data, as well as any factors described herein, such as those listed above:
811 Ticket
   Area (sq ft)
   Address
   Folder
   Work type
Gas Distribution
   Services
   Mains
   Deactivated mains
Gas Transmission
   Mains
   Deactivated mains
Electric Distribution
   Primary underground conductors
   Secondary underground conductors
   Underground transformers
   Underground pseudo services
   Streetlights
   Vault polygons
   DC conductors
Fiber
   Fiber optic cable

In some embodiments, as step of training the AI includes providing a data set including an 811 ticket as well as one or more of the 16 other features listed above as training data.

A pre-processing step includes reviewing the dataset for errors. “NEW” tickets reflect a new work site is being submitted to the L&M where a technician marks all assets from start to finish, therefore these tickets are assumed to be correct. For all non-new type tickets, actual duration may not reflect marking all GIS assets in the project boundary. For example, the remark type (REMK) indicates that either all or part of an old ticket needs to be remarked, perhaps because of rain or wear. The amend type (AMND) indicates an adjustment made to a ticket boundary which may or may not need to be remarked. These tickets should be evaluated and excluded from the training data set should a discrepancy exist.

In some embodiments, ticket duration is captured manually in the L&M iOS (any reference to iOS is also a reference to any suitable operating system) app by technicians opening and closing tickets: this manual capture introduces errors. In some embodiments, two true/false fields were created and tickets for which both these conditions were true were excluded. In some embodiments, the overnight worklog field indicates if a ticket was open at 12 am midnight and the 12 hour worklog field indicates whether a single worklog within the ticket was open for more than 12 hours. If both are true, in some embodiments, the assumption was made that a technician did not properly open and close a ticket and the duration was inaccurate and should thus be excluded from the training set.

Technicians submit worklogs to track work on tickets. Many worklog types (e.g., no delineation complete, no excavation to take place, no remark required, bad ticket info, excavated before marked, no access to delineated area, canceled ticket, located by utility crew) indicate that typical locating work was not performed and were excluded from the training data. In some embodiments, tickets with zero duration or less were assumed to be errors and were also filtered out.

In some embodiments, a ticket was labeled as single address if the ticket had a number followed by a word (123 Main St) and multi address if not (Main St, Highway 99). This is a useful feature because multi-address tickets take longer to work. A multi-address ticket could be a whole street or an entire apartment complex or a technician may have to determine exactly where the exact project location is.

In some embodiments, excavators describe their project type in the work type column (free text) and common project types were pulled as features for labeling. Horizontal, vertical, and other boring types are useful to duration because boring jobs have a higher risk of resulting in dig-ins (i.e., unplanned contact with asset). Thus, tickets with boring (especially horizontal boring) take longer to locate because the work has to be done with high accuracy and with more detail. In some embodiments, other work types also extracted as features for training include hand dig, sewer, gas, and pole replacement according to some embodiments.

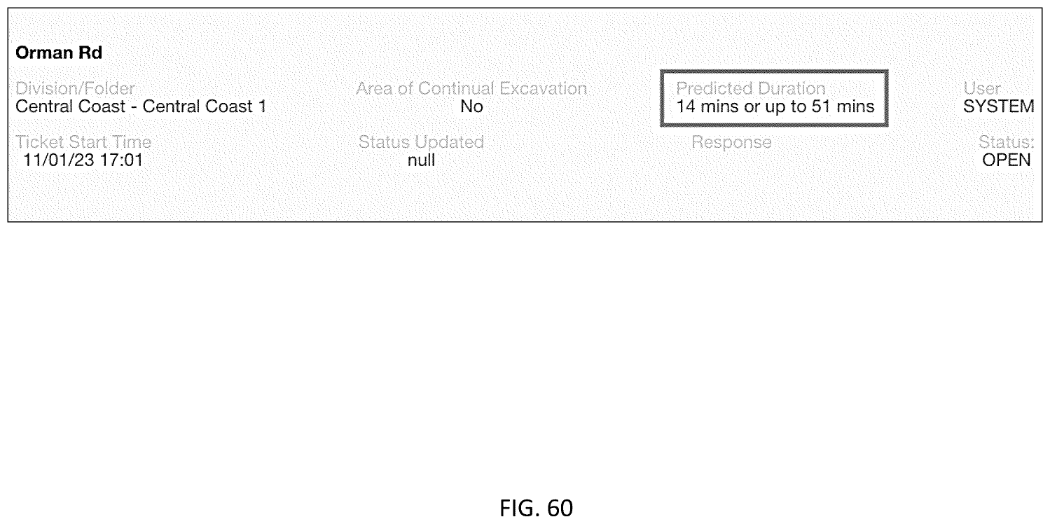

Once trained with historical ticket data, in some embodiments, the AI model is configured to output a mean regression for ticket duration. In some embodiments, ticket duration includes, on average, how many minutes required for a technician to complete a ticket. In some embodiments, completing a ticket includes locating and marking all underground utility assets within an 811 project area. In some embodiments, the AI model is configured to output a quantile regression including a 90% prediction interval for ticket duration. In some embodiments, the prediction interval (5^{th} and 95^{th}) such that 90% of the time, the true duration will fall between the intervals. In some embodiments, the 5^{th} percentile is assumed to always be 0 minutes. FIG. 60 shows a ticket header in the L&M supervisor dashboard showing mean and upper interval prediction according to some embodiments. In some embodiments, the prediction is displayed on any device described herein.

In some embodiments, the system is configured to execute a unitization, which including using the duration model's predictions to standardize and assess the difficulty of the work required to create a ticket. In the prior art, ticket counts, which include the number of tickets a division receives, are used as an industry standard to characterize a division's workload. However, ticket counts do not take into consideration the difficulty of the ticket workload. For example, if Division A and Division B both got 10K tickets in one month, one could assume they would have the same amount of work and require the same staffing. However, in practice this is not the case, because some tickets are harder to resolve and require more work than others.

In some embodiments, the duration (AI) model is configured to include ticket size, ticket description, and/or Geographical Information System (GIS) asset counts in the analysis. In some embodiments, these features are used to generate an estimate of ticket difficulty using the duration model prediction by converting a predicted minute into a unit. In some embodiments, the system is configured to generate a unitization dashboard that includes an aggregate of the duration model predictions and displays a comparison of the predicted workload between the divisions and time periods.

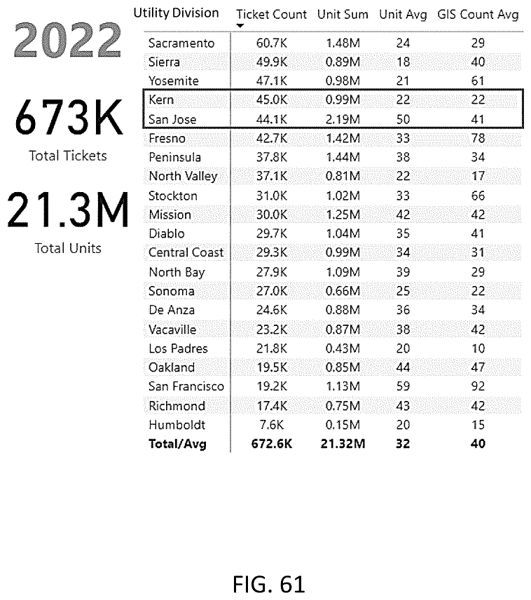

FIG. 61 shows a portion of the unitization dashboard according to some embodiments. In some embodiments, FIG. 61 shows that the Kern and San Jose divisions both received about 45 k tickets in 2022. With only this information, one could think that the divisions would have similar workloads and need similar staffing. However, using the system and methods described herein, on average a ticket in San Jose was predicted to take 50 mins and contain 41 GIS assets versus 22 mins and 22 assets in Kern. In some embodiments, the system is configured to create and display a unit summation column, which in this non-limiting example, shows that in 2022 San Jose's total ticket units was 2.2 million (i.e., predicted minutes) while Kern's was less than half of that value. This analysis according to some embodiments enables the utility to proactively assign resources accordingly.

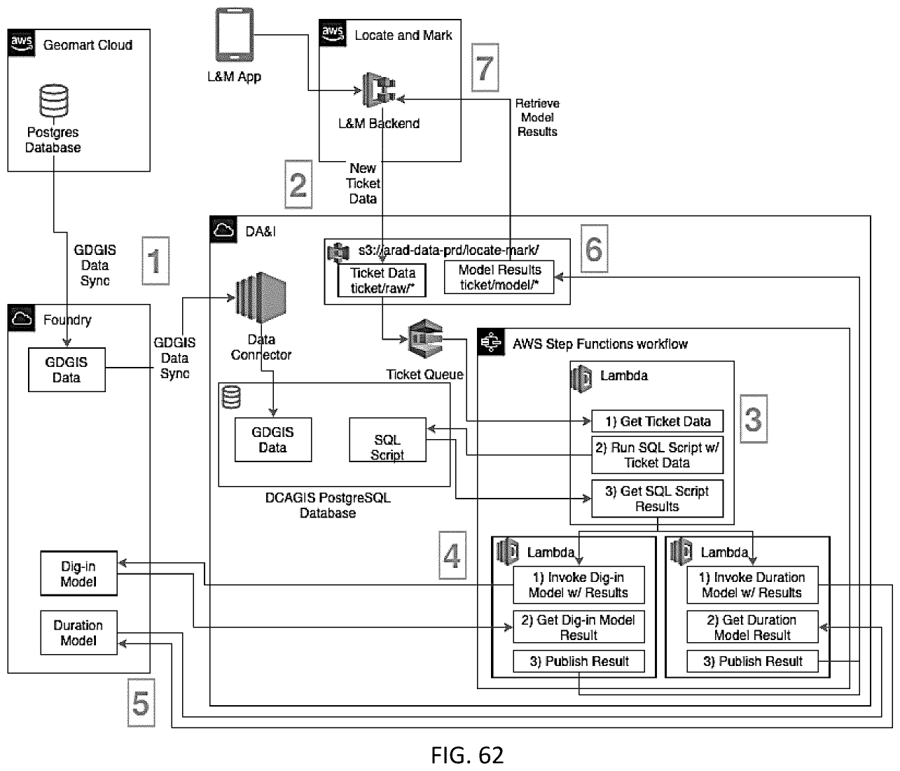

FIG. 62 illustrates a non-limiting system architecture integrating the duration model according to some embodiments. In some embodiments, GIS data from geospatial resources (e.g., Geosmart) is pushed to an AI model module (labeled as Foundry) then to L&M PostgreSQL database. In some embodiments, the 811 ticket data is pushed from the L&M backend to the AWS S3 bucket. In some embodiments, the AWS Lambda function receives the 811 ticket boundary polygon and performs a spatial selection with the GIS data. In some embodiments, the AWS Lambda function sends the 811 ticket and GIS input data to the duration model and/or dig-in model in Foundry. In some embodiments, the duration model returns the prediction. In some embodiments, the AWS Lambda function saves the prediction in an S3 bucket. In some embodiments, the L&M backend receives and displays the prediction in one or dashboards described herein.

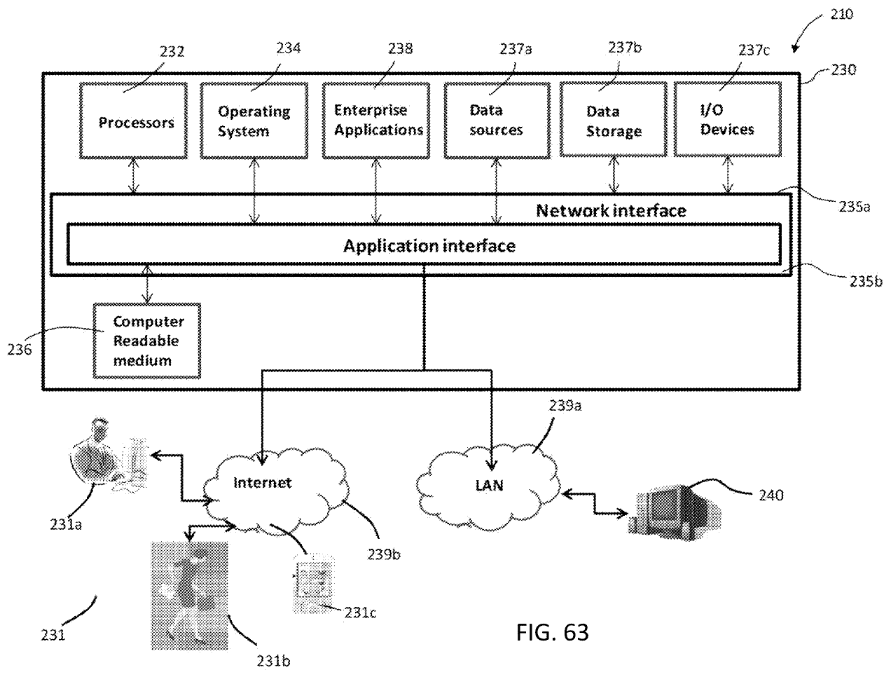

FIG. 63 illustrates a computer system enabling systems and methods in accordance with some embodiments. In some embodiments, the computer system 210 is configured to include and/or operate and/or process computer-executable code of one or more of the above-mentioned program logic, software modules, and/or systems. Further, in some embodiments, the computer system 210 is configured to operate and/or display information within one or more graphical user interfaces. In some embodiments, the computer system 210 comprises a cloud server and/or is configured to be coupled to one or more cloud-based server systems.

In some embodiments, the system 210 comprises at least one computing device including at least one processor 232. In some embodiments, the at least one processor 232 can include a processor residing in, or coupled to, one or more server platforms. In some embodiments, the system 210 can include a network interface 235a and an application interface 235b coupled to the least one processor 232 capable of processing at least one operating system 234. Further, in some embodiments, the interfaces 235a, 235b coupled to at least one processor 232 can be configured to process one or more of the software modules 238 (e.g., such as enterprise applications). In some embodiments, the software modules 238 can include server-based software, and operate to host at least one user account and/or at least one client account, and operate to transfer data between one or more of these accounts using the at least one processor 232.

With the above embodiments in mind, it should be understood that the invention can employ various computer-implemented operations involving data stored in computer systems. Moreover, in some embodiments, the above-described databases and models described throughout can store analytical models and other data on computer-readable storage media within the system 210 and on computer-readable storage media coupled to the system 210. In addition, in some embodiments, the above-described applications of the system is configured to be stored on computer-readable storage media within the system 210 and/or on computer-readable storage media coupled to the system 210. In some embodiments, these operations are those requiring physical manipulation of physical quantities. Usually, though not necessarily, in some embodiments, these quantities take the form of electrical, electromagnetic, or magnetic signals, optical or magneto-optical form capable of being stored, transferred, combined, compared, and otherwise manipulated. In some embodiments, the system 210 comprises at least one computer readable medium 236 coupled to at least one data source 237a, and/or at least one data storage device 237b, and/or at least one input/output device 237c.

In some embodiments, the invention is embodied as computer readable code on a computer readable medium 236. In some embodiments, the computer readable medium 236 is any data storage device that can store data, which can thereafter be read by a computer system (such as the system 210). In some embodiments, the computer readable medium 236 is any physical or material medium that can be used to tangibly store the desired information or data or instructions and which can be accessed by a computer or processor 232.

In some embodiments, the computer readable medium 236 includes hard drives, network attached storage (NAS), read-only memory, random-access memory, FLASH based memory, CD-ROMs, CD-Rs, CD-RWs, DVDs, magnetic tapes, other optical and non-optical data storage devices. In some embodiments, various other forms of computer-readable media 236 transmit or carry instructions to a computer 240 and/or at least one user 231, including a router, private or public network, or other transmission device or channel, both wired and wireless. In some embodiments, the software modules 238 is configured to send and receive data from a database (e.g., from a computer readable medium 236 including data sources 237a and data storage 237b that comprises a database), and data is received by the software modules 238 from at least one other source. In some embodiments, at least one of the software modules 238 is configured within the system to output data to at least one user 231 via at least one graphical user interface rendered on at least one digital display.

In some embodiments, the computer readable medium 236 is distributed over a conventional computer network via the network interface 235a where the system embodied by the computer readable code can be stored and executed in a distributed fashion. For example, in some embodiments, one or more components of the system 210 is configured to send and/or receive data through a local area network (“LAN”) 239a and/or an internet coupled network 239b (e.g., such as a wireless internet). In some further embodiments, the networks 239a, 239b are configured to include wide area networks (“WAN”), direct connections (e.g., through a universal serial bus port), and/or other forms of computer-readable media 236, and/or any combination thereof.

In some embodiments, components of the networks 239a, 239b include any number of user devices such as personal computers including for example desktop computers, and/or laptop computers, and/or any fixed, generally non-mobile internet appliances coupled through the LAN 239a. For example, some embodiments include personal computers 240a coupled through the LAN 239a that can be configured for any type of user including an administrator. Some embodiments include personal computers coupled through network 239b. In some further embodiments, one or more components of the system 210 are coupled to send or receive data through an internet network (e.g., such as network 239b).

For example, some embodiments include at least one user 231 coupled wirelessly and accessing one or more software modules of the system including at least one enterprise application 238 via an input and output (“I/O”) device 237c. In some other embodiments, the system 210 can enable at least one user 231 to be coupled to access enterprise applications 238 via an I/O device 237c through LAN 239a. In some embodiments, the user 231 can comprise a user 231a coupled to the system 210 using a desktop computer, laptop computers, and/or any fixed, generally non-mobile internet appliances coupled through the internet 239b. In some further embodiments, the user 231 comprises a mobile user 231b coupled to the system 210. In some embodiments, the user 231b can use any mobile computing device 231c to wireless coupled to the system 210, including, but not limited to, personal digital assistants, and/or cellular phones, mobile phones, or smart phones, and/or pagers, and/or digital tablets, and/or fixed or mobile internet appliances.

Acting as Applicant's own lexicographer, Applicant defines the use of and/or, in terms of “A and/or B,” to mean one option could be “A and B” and another option could be “A or B.” Such an interpretation is consistent with the USPTO Patent Trial and Appeals Board ruling in ex parte Gross, where the Board established that “and/or” means element A alone, element B alone, or elements A and B together.

Some embodiments of the system are presented with specific values and/or setpoints. These values and setpoints are not intended to be limiting, and are merely examples of a higher configuration versus a lower configuration and are intended as an aid for those of ordinary skill to make and use the system. In addition, “substantially” and “approximately” when used in conjunction with a value encompass a difference of 10% or less of the same unit and scale of that being measured. In some embodiments, “substantially” and “approximately” are defined as presented in the specification.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Modifications to the illustrated embodiments and the generic principles herein can be applied to all embodiments and applications without departing from embodiments of the system. Also, it is understood that features from some embodiments presented herein are combinable with other features according to some embodiments. Thus, some embodiments of the system are not intended to be limited to what is illustrated but are to be accorded the widest scope consistent with all principles and features disclosed herein.

We claim:

1. A system for 811 ticket ingestion and assignment comprising:
one or more computers comprising one or more processors and one or more non-transitory computer readable media, the one or more non-transitory computer readable media including instructions stored thereon that when executed by the one or more processors cause the one or more computers to:
receive, by the one or more processors, an 811 ticket from an 811 ticket provider;
analyze, by the one or more processors, an 811 ticket content; and
generate, by the one or more processors, a ticket dashboard comprising the 811 ticket content in a different format than which the 811 ticket was received.

2. The system of claim 1,
wherein the 811 ticket is received as an email.

3. The system of claim 1,
wherein analyzing the 811 ticket includes determining an email type.

4. The system of claim 1, further comprising:
wherein analyzing the 811 ticket includes determining if the 811 ticket needs to be processed.

5. The system of claim 1,
wherein the one or more non-transitory computer readable media further include instructions stored thereon that when executed by the one or more processors cause the one or more computers to:
create, by the one or more processors, a technician ticket by extracting information from the 811 ticket and formatting the information for display on the ticket dashboard.

6. The system of claim 5,
wherein the one or more non-transitory computer readable media further include instructions stored thereon that when executed by the one or more processors cause the one or more computers to:
assign, by the one or more processors, a unique folder ID to the technician ticket.

7. The system of claim 6,
wherein the one or more non-transitory computer readable media further include instructions stored thereon that when executed by the one or more processors cause the one or more computers to:
organize, by the one or more processors, a plurality of technician tickets into workflows for individual technicians based on the unique folder ID.

8. The system of claim 1,
wherein the system is configured to generate assignments for a plurality of technician tickets based on key words in the 811 ticket and/or defined geographical boundaries associated with the 811 ticket.

9. The system of claim 2,
wherein the system is configured to automatically generate an encompassing shape around a work area on a map based on an analysis of the email.

10. The system of claim 1,
further comprising a duration model configured to generate a prediction including an amount of time needed for a technician to complete a ticket.

11. The system of claim 10,
wherein completing the ticket includes the technician determining a type of utilities, their location, and/or any specific requirements or precautions within geographical boundaries from the 811 ticket.

12. The system of claim 10,
wherein the duration model includes an AI model configured to analyze information from the 811 ticket.

13. The system of claim 12,
wherein the AI model is configured to include ticket size, ticket description, and/or Geographical Information System (GIS) asset counts in for the prediction.

14. The system of claim 12,
wherein the AI model is configured to output a quantile regression including a prediction interval for ticket duration.

15. The system of claim 12,
wherein the AI model is configured to output a mean regression for ticket duration.
